(19) United States
(12) Patent Application Publication
(10) Pub. No.: US 2012/0326097 A1
(43) Pub. Date: Dec. 27, 2012

(54) Half-Heusler Alloys with Enhanced Figure of Merit and Methods of Making

(75) Inventors: Zhifeng Ren, Newton, MA (US); Xiao Yan, Chesnut Hill, MA (US); Giri Joshi, Brighton, MA (US); Gang Chen, Carlisle, MA (US); Bed Poudel, Brighton, MA (US); James Christopher Caylor, Melrose, MA (US)

(73) Assignees: Trustees of Boston College, Chesnut Hill, MA (US); GMZ Energy, Inc., Waltham, MA (US)

(21) Appl. No.: 13/330,216

(22) Filed: Dec. 19, 2011

Related U.S. Application Data
(60) Provisional application No. 61/424,878, filed on Dec. 20, 2010.

(51) Int. Cl. H01B 1/02; B22F 3/10; B22F 1/00

(52) U.S. Cl. 252/513; 419/33; 419/23

(57) ABSTRACT

Thermoelectric materials and methods of making thermoelectric materials having a nanometer mean grain size less than 1 micron. The method includes combining and arc melting constituent elements of the thermoelectric material to form a liquid alloy of the thermoelectric material and casting the liquid alloy of the thermoelectric material to form a solid casting of the thermoelectric material. The method also includes ball milling the solid casting of the thermoelectric material into nanometer mean size particles and sintering the nanometer size particles to form the thermoelectric material having nanometer scale mean grain size.

This application claims the benefit of U.S. Provisional Application No. 61/424,878, filed Dec. 20, 2010.

This invention was made with government support under grant number DOE DE-FG02-00ER45805 (Z.F.R.) awarded by US Department of Energy. The government has certain rights in the invention.

### FIELD

The present invention is directed to thermoelectric materials and specifically to half-Heusler alloys.

### BACKGROUND

Half-Heuslers (HHs) are intermetallic compounds which have great potential as high temperature thermoelectric materials for power generation. However, the dimensionless thermoelectric figure-of-merit (ZT) of HHs is lower than that of the most state-of-the-art thermoelectric materials. HHs are complex compounds: MCoSb (p-type) and MNiSn (n-type), where M can be Ti or Zr or Hf or combination of two or three of the elements. They form in cubic crystal structure with a F4/3m (No. 216) space group. These phases are semiconductors with 18 valence electron count (VEC) per unit cell and a narrow energy gap. The Fermi level is slightly above the top of the valence band. The HH phases have a fairly decent Seebeck coefficient with moderate electrical conductivity. The performance of thermoelectric materials depends on ZT, defined by ZT=(S²σ/κ)T, where σ is the electrical conductivity, S the Seebeck coefficient, κ the thermal conductivity, and T the absolute temperature. Half-Heusler compounds may be good thermoelectric materials due to their high power factor (S²σ). It has been reported that the MNiSn phases are promising n-type thermoelectric materials with exceptionally large power factors and MCoSb phases are promising p-type materials. In recent years, different approaches have been reported that have improved the ZT of half-Heusler compounds by mainly optimizing the compositions. However, the observed peak ZT is only around 0.5 for p-type and 0.8 for n-type due to their relatively high thermal conductivity.

### SUMMARY

An embodiment relates to a method of making a thermoelectric material having a mean grain size less than 1 micron. The method includes combining arc melting constituent elements of the thermoelectric material to form a liquid alloy of the thermoelectric material and casting the liquid alloy of the thermoelectric material to form a solid casting of the thermoelectric material. The method also includes ball milling the solid casting of the thermoelectric material into nanometer scale mean size particles and sintering the nanometer size particles to form the thermoelectric material having nanometer scale mean grain size.

Another embodiment relates to a thermoelectric half-Heusler material comprising grains having at least one of a median grain size and a mean grain size less than one micron. In one aspect, the half-Heusler material has a formula Hf_{1+δ-x-y}ZrₓTi_{y}NiSn_{1+δ-z}Sb_{z}, where 0≦x≦1.0, 0≦y≦1.0, 0≦z≦1.0, and −0.1≦δ≦0.1, such as Hf_{1-x-y}ZrₓTi_{y}NiSn_{1-z}Sb_{z}, where 0≦x≦1.0, 0≦y≦1.0, and 0≦z≦1.0 when δ=0. In another aspect, the half-Heusler material has a formula Hf_{1+δ-x-y}ZrₓTi_{y}CoSb_{1+δ-z}Sn_{z}, where 0≦x≦1.0, 0≦y≦1.0, 0≦z≦1.0, and −0.1≦δ≦0, such as Hf_{1-x-y}ZrₓTi_{y}CoSb_{1-z}Sn_{z}, where 0≦x≦1.0, 0≦y≦1.0, and 0≦z≦1.0 when δ=0.

### BRIEF DESCRIPTION OF THE DRAWINGS

FIG. 1 illustrates XRD patterns (a) (bottom curve: arc melted ingot; middle curve: ball milled powder; and top curve: hot pressed sample). SEM images of arc-melted ingot (b), ball milled nanopowder with TEM image as inset (c), and hot-pressed Hf_{0.75}Zr_{0.25}NiSn_{0.99}Sb_{0.01} samples (d).

FIG. 2 illustrates low-(a), and high-magnification (b-d) TEM images of nanostructured Hf_{0.75}Zr_{0.25}NiSn_{0.99}Sb_{0.01} samples made by ball milling and hot pressing. The inset in b) is to show the crystalline nature of grain 1 with a rotation. The inset in d) is to show the grains as perfect crystalline structures.

FIG. 3 illustrates temperature dependent electrical conductivity (a), Seebeck coefficient (b), power factor (c), total thermal conductivity (d), lattice thermal conductivity (e), and ZT (f) of nanostructured Hf_{0.75}Zr_{0.25}NiSn_{0.99}Sb_{0.01} samples (filled squares, triangles, and diamonds), and the annealed sample at 800° C. for 12 hours in air (stars) (the line is for viewing guidance only) in comparison with the ingot sample (open circles) which matches the previously reported best n-type half-Heusler composition.

FIG. 4 illustrates temperature dependent specific heat capacity (a), and thermal diffusivity (b) of arc-melted and then ball milled and hot pressed Hf_{0.75}Zr_{0.25}NiSn_{0.99}Sb_{0.01} samples (filled squares, triangles, and diamonds), and the annealed sample at 800° C. for 12 hours in air (stars) in comparison with the ingot sample (open circles).

FIG. 5 illustrates the temperature dependent electrical conductivity (FIG. 5a), Seebeck coefficient (FIG. 5b), power factor (FIG. 5c), thermal conductivity (FIG. 5d), and ZT (FIG. 5e) of arc melted and ball milled Hf_{0.75}Zr_{0.25}NiSn_{1-z}Sb_{z} (z=0.005, 0.01, 0.025) compositions arc melted and ball milled in-house (points) and arc melted by vendor and ball milled in-house (lines).

FIG. 6 illustrates the temperature dependent electrical resistivity (FIG. 6a), Seebeck coefficient (FIG. 6b), thermal conductivity (FIG. 6c), and ZT (FIG. 6d) of arc melted and ball milled (15 hrs, and pressed at 1000° C.) Hf₁₋ₓTiₓZr_{0.25}NiSn_{0.99}Sb_{0.01} (x=0, 0.25, 0.5, 0.65).

FIG. 7 illustrates the temperature dependent electrical resistivity (FIG. 7a), Seebeck coefficient (FIG. 7b), thermal conductivity (FIG. 7c), and ZT (FIG. 7d) of arc melted and ball milled Hf_{0.75}Zr_{0.25}NiSn_{0.99}Sb_{0.01} and Hf_{0.75}Ti_{0.25}NiSn_{0.99}Sb_{0.01}.

FIG. 8 illustrates (a) low and (b) medium magnification TEM images of, (c) selected area electron diffraction patterns of, and (d) high magnification TEM image of the ball milled Hf_{0.5}Zr_{0.5}CoSb_{0.8}Sn_{0.2} nanopowders. The selected area electron diffraction patterns in (c) show the multi-crystalline nature of an agglomerated cluster in (b).

FIG. 9 illustrates TEM images of hot pressed nanostructured Hf_{0.5}Zr_{0.5}CoSb_{0.8}Sn_{0.2} samples under low (a) and high magnifications (b, c, d). The inset in (a) is the selected area electron diffraction patterns showing the single crystalline nature of the individual grains.

FIG. 10 illustrates temperature-dependent (a) electrical conductivity, (b) Seebeck coefficient, (c) power factor, (d) total thermal conductivity, (e) lattice part of thermal conductivity, and (f) ZT of ball milled and hot pressed sample in comparison with that of the ingot for a Hf_{0.5}Zr_{0.5}CoSb_{0.8}Sn_{0.2} material.

FIG. 11 illustrates temperature-dependent specific heat (a) and thermal diffusivity (b) of ball milled and hot pressed sample in comparison with that of the ingot for a Hf_{0.5}Zr_{0.5}CoSb_{0.8}Sn_{0.2} material.

FIG. 12 illustrates the effect of bill milling time on the temperature-dependent (a) electrical conductivity, (b) Seebeck coefficient, (c) power factor, (d) total thermal conductivity, (e) lattice part of thermal conductivity, and (f) ZT of ball milled and hot pressed Hf_{0.5}Zr_{0.5}CoSb_{0.8}Sb_{0.2}.

FIG. 13 illustrates XRD patterns of samples of Hf_{0.75}TiₓZr_{0.25}NiSn_{0.99}Sb_{0.01} (x=0, 0.25, 0.5, and 0.65).

FIG. 14 illustrates TEM images of samples of Hf_{0.75}Zr_{0.25}NiSn_{0.99}Sb_{0.01} (FIGS. 14a & b) and Hf_{0.5}Ti_{0.25}Zr_{0.25}NiSn_{0.99}Sb_{0.11} (FIGS. 14c & d).

FIG. 15 illustrates (a) temperature dependent electrical conductivity, (b) Seebeck coefficient, (c) thermal diffusivity, (d) specific heat capacity, (e) thermal conductivity, and (f) ZT of nanostructured Hf_{0.75}TiₓZr_{0.25}NiSn_{0.9.9} Sb_{0.01} (x=0.25, 0.5, and 0.65) in comparison to previously reported (Hf, Zr)-based best n-type half-Heusler Hf_{0.75}Zr_{0.25}NiSn_{0.99}Sb_{0.01}.

FIG. 16 illustrates carrier concentration and mobility of nanostructured Hf_{0.75}TiₓZr_{0.25}NiSn_{0.99}Sb_{0.01} (x=0, 0.25, 0.5, and 0.65) at room temperature.

FIG. 17 illustrates (a) XRD patterns and (b) lattice parameters extracted from XRD patterns of as-pressed Hf₁₋ₓTiₓCoSb_{0.8}Sn_{0.2} (x=0.1, 0.2, 0.3 and 0.5) samples.

FIG. 18 illustrates (a) SEM image and (b-d) TEM images of as-pressed Hf_{0.8}Ti_{0.2}CoSb_{0.8}Sn_{0.2} sample.

FIG. 19 illustrates the temperature-dependent (a) electrical conductivity, (b) Seebeck coefficient, (c) power factor, (d) thermal conductivity, (e) lattice thermal conductivity, and (f) ZT of Hf₁₋ₓTiₓCoSb_{0.8}Sn_{0.2} (x=0.1, 0.2, 0.3 and 0.5) samples. The lattice thermal conductivities of Hf₁₋ₓTiₓCoSb_{0.8}Sn_{0.2} (x=0.1, 0.2, 0.3 and 0.5) samples at room temperature are plotted in comparison with molecular dynamics (MD) calculations on Hf₁₋ₓTiₓCoSb in the inset of FIG. 19e.

FIG. 20 illustrates the temperature-dependent (a) electrical conductivity, (b) Seebeck coefficient, (c) power factor, (d) thermal conductivity, (e) lattice thermal conductivity, and (f) ZT of Hf_{0.8}Ti_{0.2}CoSb_{0.8}Sn_{0.2} and Hf_{0.5}Zr_{0.5}CoSb_{0.8}Sn_{0.2}. The ZT of p-type SiGe is also included in FIG. 20f for comparison.

### DETAILED DESCRIPTION

An enhancement in the dimensionless thermoelectric figure-of-merit (ZT) of n-type half-Heusler materials using a nanocomposite approach has been achieved. A peak ZT of 1.0 was achieved at 600-700° C., which is about 25% higher than the previously reported highest value. In an embodiment, the samples were made by ball milling ingots of composition Hf_{0.75}Zr_{0.25}NiSn_{0.99}Sb_{0.01} into nanopowders and DC hot pressing the powders into dense bulk samples. The ingots are formed by arc melting the elements. The ZT enhancement mainly comes from reduction of thermal conductivity due to increased phonon scattering at grain boundaries and crystal defects, and optimization of antimony doping.

By using a nanocomposite half-Heusler material, the inventors have achieved a greater than 35% ZT improvement from 0.5 to 0.8 in p-type half-Heusler compounds at temperatures above 400° C. Additionally, the inventors have achieved a 25% improvement in peak ZT, from 0.8 to 1.0 at temperatures above 400° C., in n-type half-Heusler compounds by the same nanocomposite approach. The ZT enhancement is not only due to the reduction in the thermal conductivity but also an increase in the power factor. These nanostructured samples may be prepared, for example, by DC hot pressing a ball milled nanopowder from ingots which are initially made by an arc melting process. In an embodiment, the hot pressed, dense bulk samples are nanostructured with grains having a mean grain size less than 300 nm in which at least 90% of the grains are less than 500 nm in size. In an embodiment, the grains have a mean size in a range of 10-300 nm. In an embodiment, the grains have a mean size of around 200 nm. Typically, the grains have random orientations. Further, many grains may include 10-50 nm size (e.g., diameter or width) nanodot inclusions within the grains.

Embodiments of the half-Heusler materials may include varying amounts of Hf, Zr, Ti, Co, Ni, Sb, Sn depending on whether the material is n-type or p-type. Other alloying elements such as Pb may also be added. Example p-type materials include, but are not limited to, Co containing and Sb rich/Sn poor Hf_{0.5}Zr_{0.5}CoSb_{0.8}Sn_{0.2}, Hf_{0.3}Zr_{0.7}CoSb_{0.7}Sn_{0.3}, Hf_{0.5}Zr_{0.5}CoSb_{0.8}Sn_{0.2}+1% Pb, Hf_{0.5}Ti_{0.5}CoSb_{0.8}Sn_{0.2}, and Hf_{0.5}Ti_{0.5}CoSb_{0.6}Sn_{0.4}. Example n-type materials include, but are not limited to, Ni containing and Sn rich/Sb poor Hf_{0.75}Zr_{0.25}NiSn_{0.975}Sb_{0.025}, Hf_{0.25}Zr_{0.25}Ti_{0.5}NiSn_{0.994}Sb_{0.006}, Hf_{0.25}Zr_{0.25}NiSn_{0.99}Sb_{0.01} (Ti_{0.30}Hf_{0.35}Zr_{0.35})Ni(Sn_{0.994}Sb_{0.006}) Hf_{0.25}Zr_{0.25}Ti_{0.5}NiSn_{0.99}Sb_{0.019} Hf_{0.5}Zr_{0.25}Ti_{0.25}NiSn_{0.99}Sb_{0.01} and (Hf,Zr)_{0.5}Ti_{0.5}NiSn_{0.99}Sb_{0.002}.

The ingot may be made by arc melting individual elements of the thermoelectric material in the appropriate ratio to form the desired thermoelectric material. Preferably, the individual elements are 99.9% pure. More preferably, the individual elements are 99.99% pure. In an alternative embodiment, two or more of the individual elements may first be combined into an alloy or compound and the alloy or compound used as one of the starting materials in the arc melting process. In an embodiment, ball milling results in a nanopowder with nanometer size particles that have a mean size less than 100 nm in which at least 90% of the particles are less than 250 nm in size. In another embodiment, the nanometer size particles have a mean particle size in a range of 5-100 nm.

The inventors have discovered that the figure of merit of thermoelectric materials improves as the grain size in the thermoelectric material decreases. In one embodiment of the method, thermoelectric materials with nanometer scale (less than 1 micron) grains are produced, i.e., 95%, such as 100% of the grains have a grain size less than 1 micron. Preferably, the nanometer scale mean grain size is in a range of 10-300 nm Embodiments of the method may be used to fabricate any thermoelectric material. In another embodiment, the method includes making half-Heusler materials with nanometer scale grains. The method may be used to make both p-type and n-type half-Heusler materials. In one embodiment, the half-Heusler material is n-type and has the formula Hf_{1+δ-x-y}ZrₓTi_{y}NiSn_{1+δ-z}Sb_{z}, where 0≦x≦1.0, 0≦y≦1.0, 0≦z≦1.0, and −0.1≦δ≦0.1 (to allow for slightly non-stoichiometric material), such as Hf_{1-x-y}ZrₓTi_{y}NiSn_{1-z}Sb_{z}, where 0≦x≦1.0, 0≦y≦1.0, and 0≦z≦1.0 when δ=0 (i.e., for the stoichiometric material). In another embodiment, the half-Heusler is a p-type material and has the formula Hf_{1+δ-x-y}ZrₓTi_{y}CoSb_{1+δ-z}Sn_{z}, where 0≦x≦1.0, 0≦y≦1.0, 0≦z≦1.0, and −0.1≦δ≦0 (to allow for slightly non-stoichiometric material), such as Hf_{1-x-y}ZrₓTi_{y}CoSb_{1-z}Sn_{z}, where 0≦x≦1.0, 0≦y≦1.0, and 0≦z≦1.0 when δ=0 (i.e., for the stoichiometric material).

The following examples of methods and thermoelectric materials of the present invention. These examples are illustrative and not meant to be limiting.

n-Type Half-Heusler Materials

The n-type half-Heusler materials were prepared by melting hafnium (Hf) (99.99%, Alfa Aesar), zirconium (Zr) (99.99%, Alfa Aesar) chunks, nickel (Ni) (99.99%, Alfa Aesar), tin (Sn) (99.99%, Alfa Aesar), and antimony (Sb) (99.99%, Alfa Aesar) pieces according to composition Hf_{0.75}Zr_{0.25}NiSn_{0.99}Sb_{0.01} using an arc melting process. The melted ingot was then milled for 1-50 hours to get the desired nanopowders with a commercially available ball milling machine (SPEX 800M Mixer/Mill). The mechanically prepared nanopowders were then pressed at temperatures of 900-1200° C. by using a dc hot press method in graphite dies with a 12.7 mm central cylindrical opening diameter to get nanostructured bulk half-Heusler samples.

The samples were characterized by X-ray diffraction (XRD), scanning electron microscopy (SEM), and transmission electron microscopy (TEM) to study their crystallinity, homogeneity, average grain size, and grain size distribution of the nanoparticles. These parameters affect the thermoelectric properties of the final dense bulk samples. The volume densities of these samples were measured using an Archimedes' kit.

The nanostructured bulk samples were then cut into 2 mm×2 mm×12 mm bars for electrical conductivity and Seebeck coefficient measurements on a commercial equipment (Ulvac, ZEM-3), 12.7 mm diameter discs with appropriate thickness for thermal diffusivity measurements on a laser flash system (Netzsch LFA 457) from 100 to 700° C., and 6 mm diameter discs with appropriate thickness for specific heat capacity measurements on a differential scanning calorimeter (200-F3, Netzsch Instruments, Inc.) from room temperature to 600° C. (The data point at 700° C. was extrapolated). Then, the thermal conductivity was calculated as the product of the thermal diffusivity, specific heat capacity, and volume density of the samples. To confirm the reproducibility of the sample preparation process and reliability of the measurements of nanocrystalline bulk samples, the same experimental conditions were repeated 3-6 times for each composition. It was found that the thermoelectric properties are reproducible within 5% under the same experimental conditions. The volume densities of three measured nanostructured samples (runs 1, 2 and 3) were 9.73, 9.70, and 9.65 gcm⁻³, respectively.

In embodiments, a nanostructured approach has been used to reduce the lattice thermal conductivity along with the optimization of antimony concentrations to optimize the electrical conductivity for the highest power factor. Since the ingot of Hf_{0.75}Zr_{0.25}NiSn_{0.975}Sb_{0.025} composition is the previously reported best n-type HHs with a peak ZT of 0.8, nanostructured samples of compositions Hf_{0.75}Zr_{0.25}NiSn_{1-z}Sb_{z} (z=0.005, 0.01, and 0.025) were prepared and measured. It was observed that the best ZT values are obtained with a Hf_{0.75}Zr_{0.25}NiSn_{0.99}Sb_{0.01} composition. It is believed that this is due to a nanostructuring process and optimization of antimony concentration.

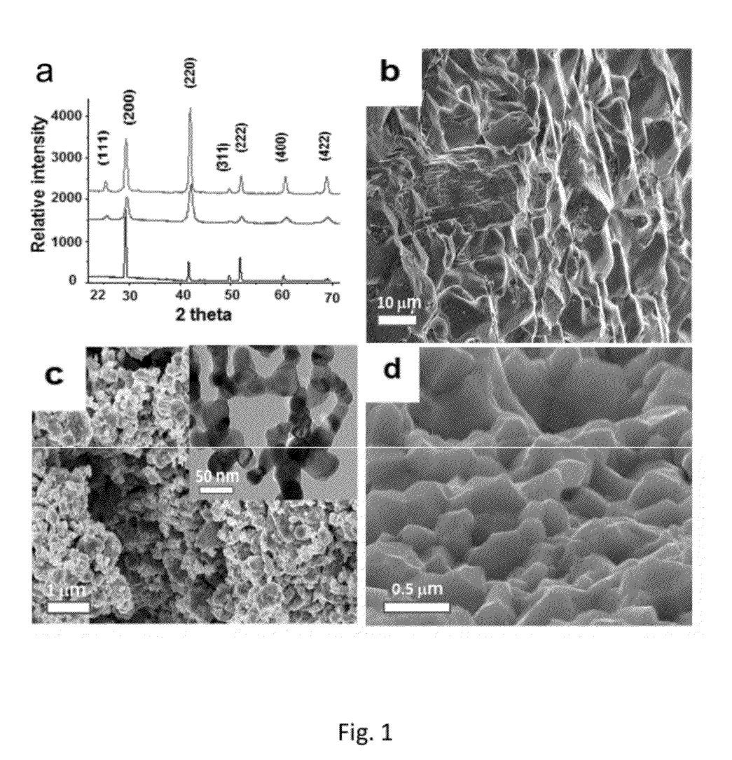

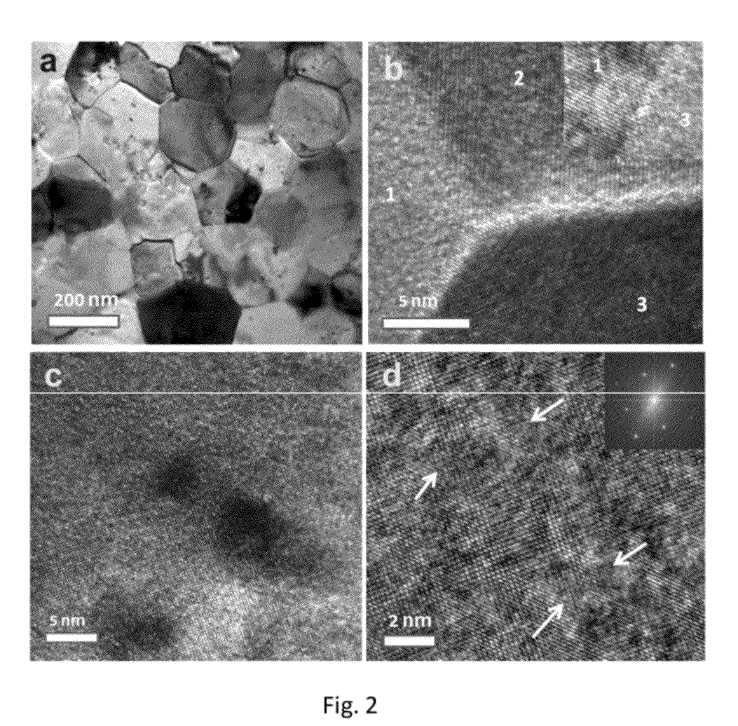

The results for the temperature dependent thermoelectric properties of n-type half-Heusler samples of composition Hf_{0.75}Zr_{0.25}NiSn_{0.99}Sb_{0.01} are provided below. FIG. 1 shows the XRD patterns (FIG. 1a) (bottom curve: ingot; middle curve: ball milled powder; and top curve: hot pressed sample), and SEM image of the fractured surface of arc-melted ingot (FIG. 1b), SEM image of the ball milled powder with TEM image as inset (FIG. 1c), and SEM image of the fractured surface of the hot pressed samples (FIG. 1d). The XRD patterns (FIG. 1a) clearly show that the sample is completely alloyed after arc melting, and the peaks are well matched with those of half-Heusler phases. FIG. 1b clearly shows that the ingot has large particles ranging from 10 micrometers and up. These large particles are easily broken into nanoparticles by ball milling (FIG. 1c) with grain size of around 50 nm (inset of FIG. 1c), and a significant grain growth takes place during the hot pressing process (FIG. 1d). Moreover, TEM has been carried out to study the microstructures of the hot pressed samples. FIG. 2 shows a low-(FIG. 2a), and high-magnification (FIGS. 2b-d) TEM images of the hot pressed Hf_{0.75}Zr_{0.25}NiSn_{0.99}Sb_{0.01} samples. TEM images (FIG. 2a) confirm the grain size observed by SEM image, in the range of around 200-300 nm, the existence of clear crystalline grain boundaries (FIG. 2b, the inset shows grain 1 is also crystalline even though it looks amorphous due to a different orientation when image was taken), some precipitates or aggregates in the matrix (FIG. 2c), and the discontinuous heavily-distorted crystal lattice, pointed by arrows (FIG. 2d). The small grains, precipitates, and lattice distortions are desirable for lower thermal conductivity due to possible increase in phonon scattering.

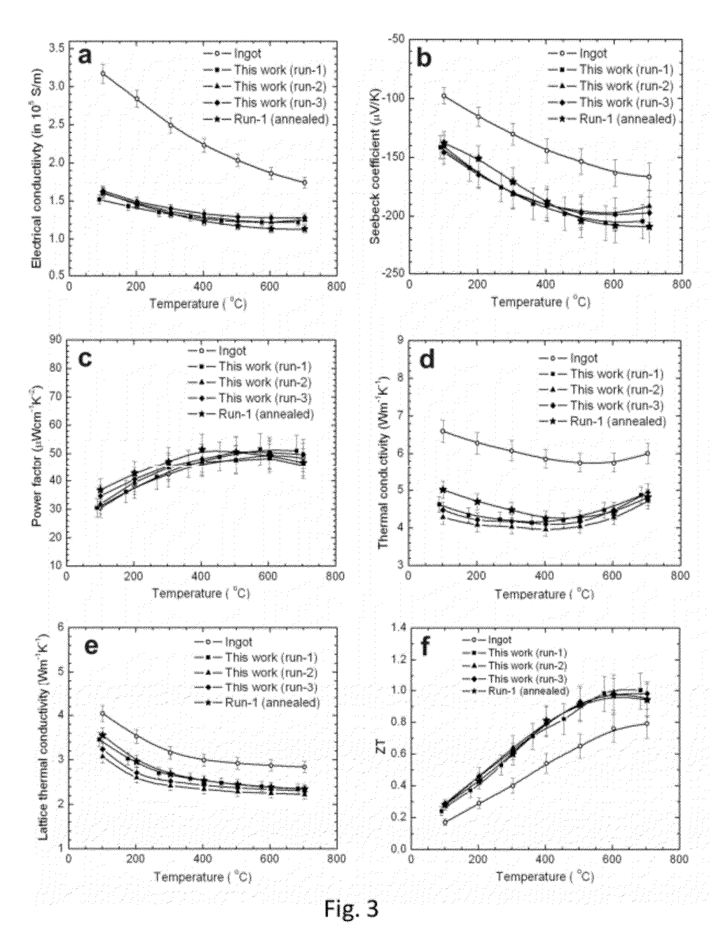

FIGS. 3a-3f show the temperature dependent electrical conductivity (FIG. 3a), Seebeck coefficient (FIG. 3b), power factor (FIG. 3c), thermal conductivity (FIG. 3d), lattice thermal conductivity (FIG. 3e), and ZT (FIG. 3f) of the three ball milled and hot pressed nanostructured samples (runs 1, 2 & 3, which are prepared by the same procedure) with a composition of Hf_{0.75}Zr_{0.25}NiSn_{0.99}Sb_{0.01} in comparison with a reference sample of the previously reported best n-type half-Heusler samples by Culp et al. with a composition of Hf_{0.75}Zr_{0.25}NiSn_{0.975}Sb_{0.025}. These nanostructured and ingot samples are measured by the same measurement systems. FIG. 3a clearly shows that the electrical conductivity of the nanostructured Hf_{0.75}Zr_{0.25}NiSn_{0.99}Sb_{0.01} samples is much lower than that of the ingot sample, which is desired for lower electronic contribution to the thermal conductivity. The Seebeck coefficient of the nanostructured Hf_{0.75}Zr_{0.25}NiSn_{0.99}Sb_{0.01} samples is higher in comparison with the ingot sample (FIG. 3b). This could be due to the lower doping (antimony) concentration. As a result, the power factor of the nanostructured Hf_{0.75}Zr_{0.25}NiSn_{0.99}Sb_{0.01} samples is almost the same as that of the reference Hf_{0.75}Zr_{0.25}NiSn_{0.975}Sb_{0.025} sample (FIG. 3c). However, the thermal conductivity of the nanostructured Hf_{0.75}Zr_{0.25}NiSn_{0.99}Sb_{0.01} sample is significantly lower than that of the reference Hf_{0.75}Zr_{0.25}NiSn_{0.975}Sb_{0.025} sample (FIG. 3d). The lower thermal conductivity of nanostructured Hf_{0.75}Zr_{0.25}NiSn_{0.99}Sb_{0.01} samples is due to both the lower electrical conductivity and the expected stronger grain boundary scattering resulting in lower lattice thermal conductivity (FIG. 3e). The lattice thermal conductivity (κ_{lattice}) was calculated by subtracting the carrier (κ_{carrier}) and bipolar (κ_{bipolar}) contributions from the total thermal conductivity (κₜₒₜₐₗ), where the carrier contribution was obtained from Wiedemann-Franz law by using temperature dependent Lorenz number, and the bipolar contribution is taken into account by κ_{lattice} being proportional to T⁻¹. Since both the ingot and nanostructured samples are heavily doped (degenerate semiconductors), a single band approximation is used to calculate the Lorenz number. As a result, a peak ZT of around 1.0 at 600-700° C. (FIG. 3f) is observed, which is about 25% higher than that of the ingot sample. Thus, n-type half-Heusler materials with ZT greater than 0.8, such as 0.8-1, at 700° C. are made using the exemplary methods. This enhancement in ZT by ball milling and hot pressing is mainly due to the reduction in electronic and thermal conductivities. FIG. 3 shows that the results of nanostructured samples are reproducible within the experimental errors. FIG. 3 also includes the results of an annealed nanostructured sample (run-1), which does not show any significant degradation in thermoelectric properties after annealing. The sample was annealed at 800° C. for 12 hours in air. This is an accelerated condition since the application temperature is expected to be below 700° C.

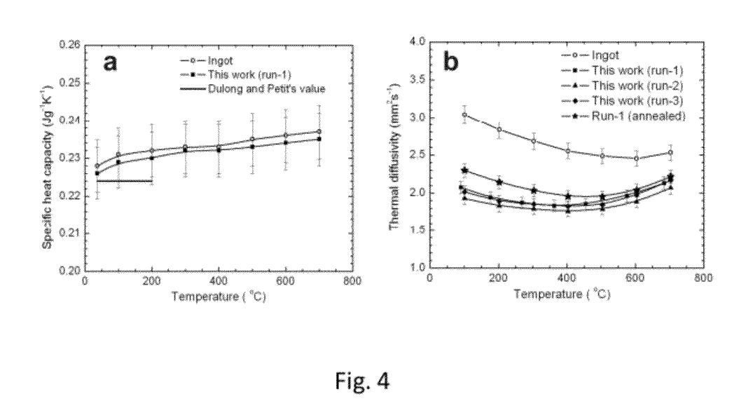

Also shown is the temperature dependent specific heat capacity (FIG. 4a) and thermal diffusivity (FIG. 4b) of nanostructured Hf_{0.75}Zr_{0.25}NiSn_{0.99}Sb_{0.01} samples in comparison with a reference Hf_{0.75}Zr_{0.25}NiSn_{0.975}Sb_{0.025} ingot sample. FIG. 4 clearly shows that the specific heat capacity of nanostructured Hf_{0.75}Zr_{0.25}NiSn_{0.99}Sb_{0.01} samples is almost the same the ingot sample (FIG. 4a) and these values agree fairly well with the Dulong and Petit value of specific heat capacity (solid line). However, the thermal diffusivity of the nanostructured Hf_{0.75}Zr_{0.25}NiSn_{0.99}Sb_{0.01} sample is significantly lower (FIG. 4b) than that of the ingot sample due to the small grain size effect and lower electronic contribution.

Since the size of the nanoparticles is useful in reducing the thermal conductivity to achieve higher ZT values, it is possible to further increase ZT of the n-type half-Heusler compounds by making the grains even smaller. In these experiments, grains of 200 nm and up (FIG. 2a) were made. It is possible, however, to achieve a grain size less than 100 nm by preventing grain growth during hot-press with a grain growth inhibitor. Exemplary grain growth inhibitors include, but are not limited to, oxides (e.g., Al₂O₃), carbides (e.g., SiC), nitrides (e.g., MN) and carbonates (e.g., Na₂CO₃).

A cost effective ball milling and hot pressing technique has been applied to n-type half-Heuslers to improve the ZT. A peak ZT of 1.0 at 700° C. is observed in nanostructured Hf_{0.75}Zr_{0.25}NiSn_{0.99}Sb_{0.01} samples, which is about 25% higher than the previously reported best peak ZT of any n-type half-Heuslers. This enhancement in ZT mainly results from reduction in thermal conductivity due to the increased phonon scattering at the grain boundaries of nanostructures and optimization of carrier contribution leading to lower electronic thermal conductivity, plus some contribution from the increased electron power factor. Further ZT improvement is possible if the grains are made less than 100 nm.

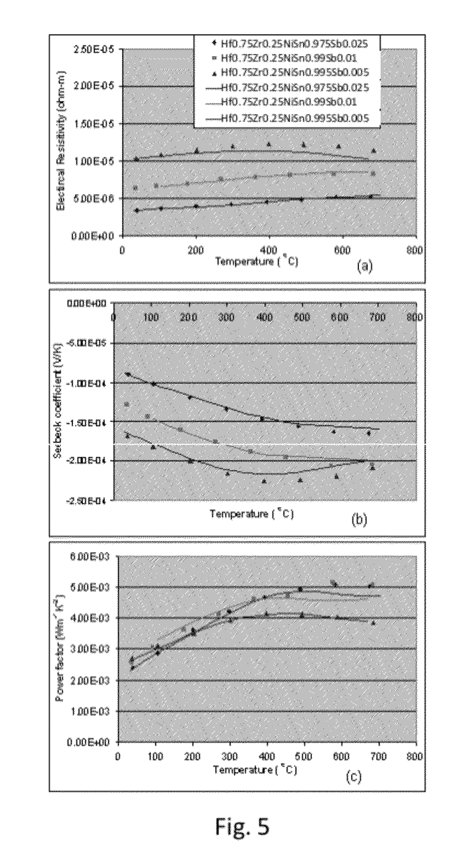

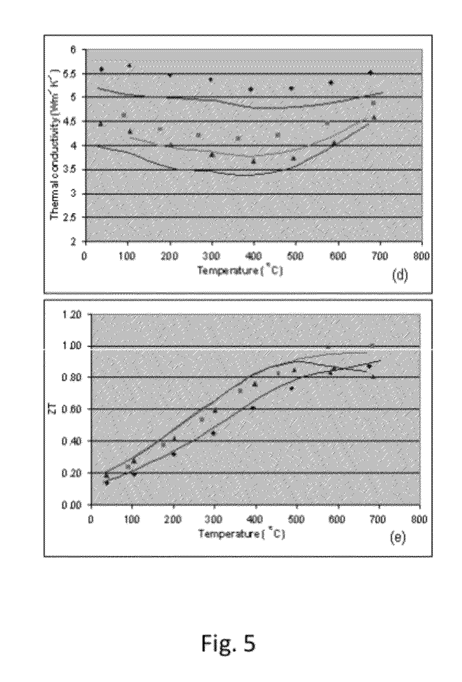

The effect of composition, arc melting and ball milling on the thermoelectric properties of other n-type thermoelectric materials are illustrated in FIGS. 5-7. FIG. 5 illustrates the temperature dependent electrical conductivity (FIG. 5a), Seebeck coefficient (FIG. 5b), power factor (FIG. 5c), thermal conductivity (FIG. 5d), and ZT (FIG. 5e) of arc melted and ball milled Hf_{0.75}Zr_{0.25}NiSn₁₋ₓSbₓ (x=0.005, 0.01, 0.025) compositions arc melted and ball milled in-house (points) and arc melted by vendor and ball milled in-house (lines). The good match between the in-house arc melted and vendor arc melted materials after bill milling indicates that the small grain size achieved in ball milling is the predominate factor in achieving superior thermoelectric properties, especially the figure of merit. FIG. 5e further indicates that a 10% improvement in the figure of merit (ZT) can be achieved with compositions in which 0.0075≦x≦0.015.

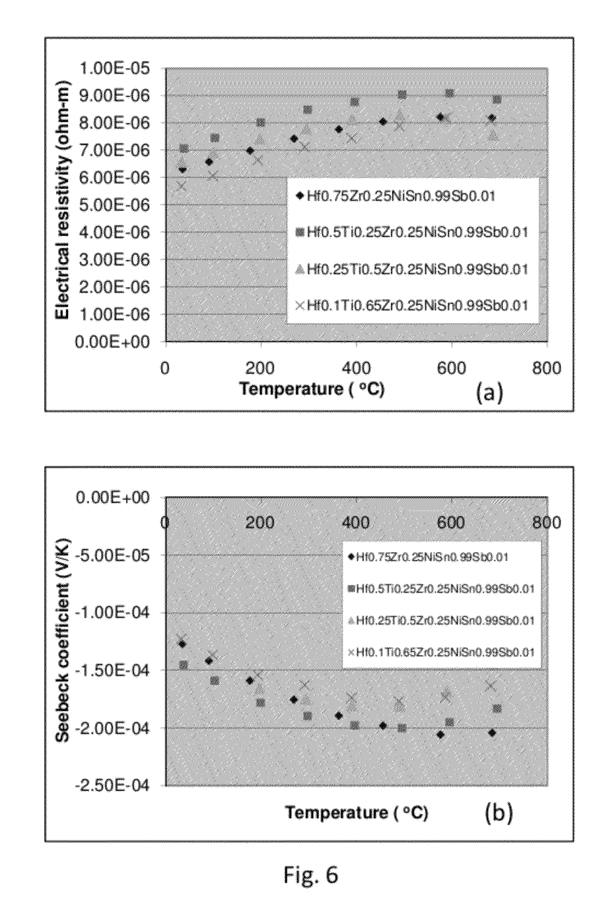

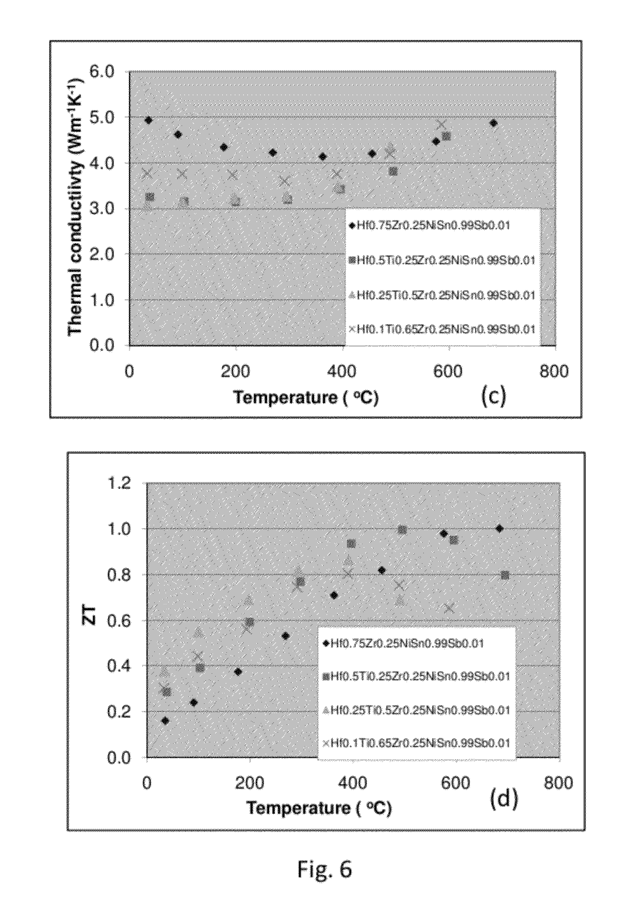

FIG. 6 illustrates the effect of adding Ti on the temperature dependent electrical conductivity (FIG. 6a), Seebeck coefficient (FIG. 6b), thermal conductivity (FIG. 6c), and ZT (FIG. 6d) of arc melted and ball milled (15 hrs, and pressed at 1000° C.) Hf₁₋ₓTiₓZr_{0.25}NiSn_{0.99}Sb_{0.01} (x=0, 0.25, 0.5, 0.65). After Ti substitution, the electrical resistivity increases at first and starts to decrease after certain Ti concentration. The Seebeck coefficient decreases at higher temperatures for all Ti doped samples. This indicates the decrease in carrier concentration after Ti substitution. After Ti substitution, the thermal conductivity decreases at lower temperatures but reaches similar values at high temperatures. This is a carrier concentration effect. The peak ZT is 1.0 for the low Ti % (0.25) containing sample, but is shifted to a lower temperature (500° C.). The peak ZT decreases with a larger concentration of Ti. Thus, a Ti free sample achieved the highest ZT (ZT=1) at higher temperature (e.g., 700° C.). Thus, n-type half-Heusler samples with Ti≦0.5 (e.g., 0≦x≦0.3) exhibit the highest ZT at higher temperatures (e.g., 700° C.).

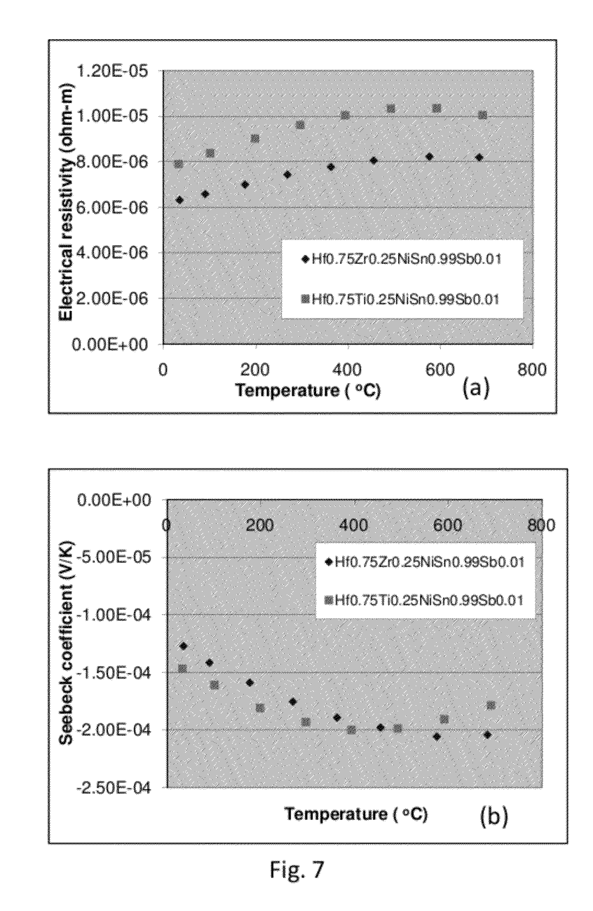

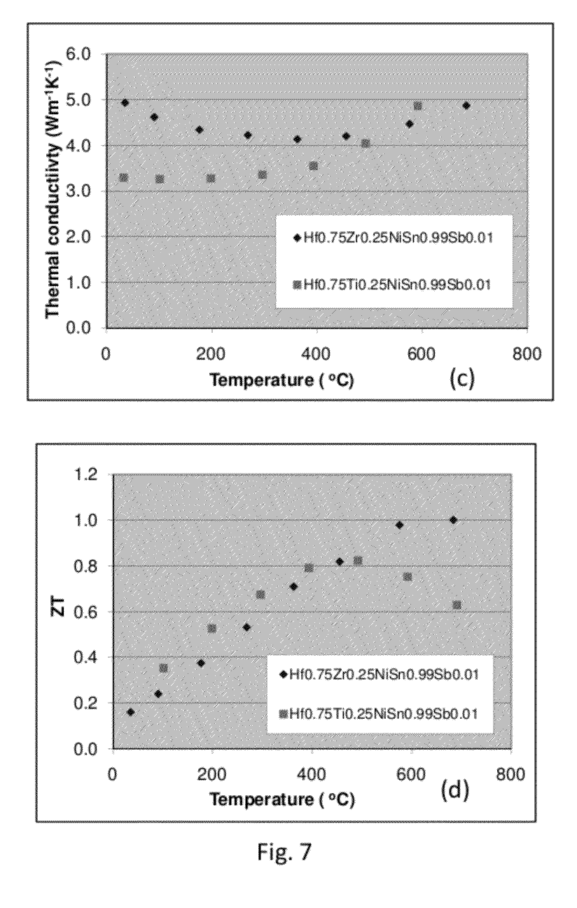

FIG. 7 illustrates the temperature dependent electrical conductivity (FIG. 7a), Seebeck coefficient (FIG. 7b), thermal conductivity (FIG. 7c), and ZT (FIG. 7d) of arc melted and ball milled Hf_{0.75}Zr_{0.25}NiSn_{0.99}Sb_{0.01} and Hf_{0.75}Ti_{0.25}NiSn_{0.99}Sb_{0.01} samples. With Ti replacement of Zr, the electrical resistivity increases. However the Seebeck coefficient increases only at lower temperatures but decreases at higher temperatures. It appears that the carrier concentration decreases with Ti replacement. The high temperature (600-700° C.) ZT of the Zr containing sample is approximately 20% higher than that of the Ti containing sample.

Therefore, as shown in FIGS. 3, 5, 6 and 7, for the n-type thermoelectric material, the figure of merit, ZT, is greater than 0.7, preferably greater than 0.8 at a temperature greater than 400° C., such as 0.7 to 1 in a temperature range of 400 to 700° C. For example, ZT is greater than 0.8, preferably greater than 0.9 at a temperature greater than or equal to 500° C., such as such 0.8 to 1 in a temperature range of 500 to 700° C. ZT is greater than 0.9 at a temperature greater than or equal to 600° C., such as such 0.9 to 1 in a temperature range of 600 to 700° C. ZT is equal to or greater than 0.9 (e.g., 0.95 to 1) at a temperature of 700° C.

### P-Type Half-Heusler Materials

In a typical experiment, the arc welded alloyed ingot with the composition of Hf_{0.5}Zr_{0.5}CoSb_{0.8}Sn_{0.2} was loaded into a jar with grinding balls and then subjected to a mechanical ball milling process. For different ball milling time intervals, a small amount of as-milled powder was taken out for size investigation by transmission electron microscope (TEM) (JEOL 2010). Correspondingly, some nanopowders were pressed into pellets with a diameter of 12.7 mm by the direct current induced hot press method. The freshly fractured surfaces of the as-pressed samples were observed by scanning electron microscope (SEM) (JEOL 6340F) and TEM to show the grain size of the samples.

To study the thermoelectric properties, polished bars of about 2×2×12 mm and disks of 12.7 mm in diameter and 2 mm in thickness were made. The bar samples were used to measure the electrical conductivity and Seebeck coefficient, and the disk samples were used to measure the thermal conductivity. The four-probe electrical conductivity and the Seebeck coefficient were measured using commercial equipment (ULVAC, ZEM3). The thermal diffusivity was measured using a laser flash system (LFA 457 Nanoflash, Netzsch Instruments, Inc.). Specific heat was determined by a DSC instrument (200-F3, Netzsch Instruments, Inc.). The volume density was measured by the Archimedes method. The thermal conductivity was calculated as the product of thermal diffusivity, specific heat, and volume density. The uncertainties are 3% for electrical conductivity, thermal diffusivity and specific heat, and 5% for Seebeck coefficient, leading to an 11% uncertainty in ZT.

The experiments were repeated more than 10 times and confirmed that the peak ZT values were reproducible within 5%.

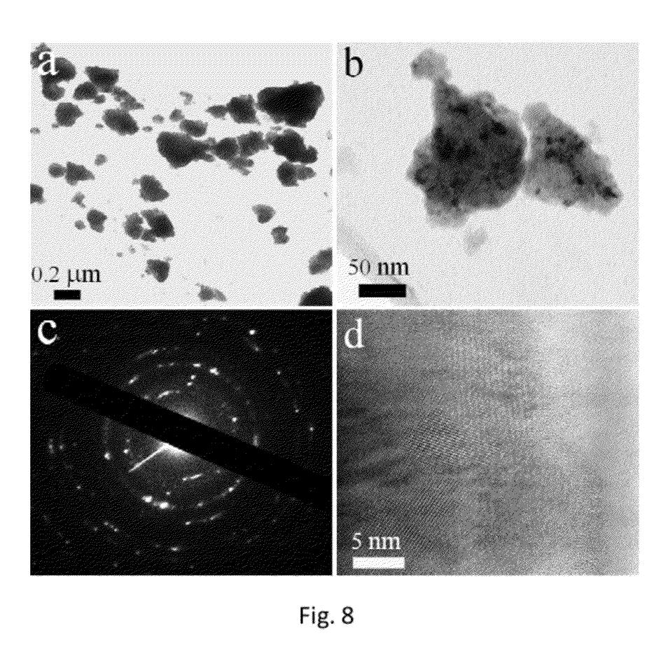

FIG. 8 shows TEM images of the ball milled nanopowders. The low (FIG. 8a) and medium (FIG. 8b) magnification TEM images show that the average cluster size of the nanopowders ranges from 20 nm to 500 nm. However, those big clusters are actually agglomerates of many much smaller crystalline powder particles, which are confirmed by the corresponding selected area electron diffraction (SAED) patterns (FIG. 8c) obtained inside a single cluster (FIG. 8b). The high resolution TEM image (FIG. 8d) shows that the sizes of the small powder particles are in the range of 5-10 nm.

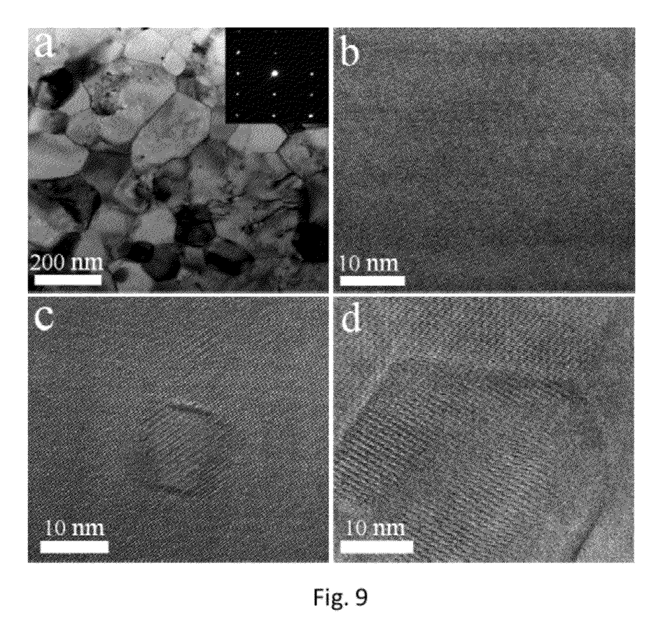

FIG. 9 displays the TEM images of the as-pressed bulk samples pressed from the ball milled powder. The low magnification TEM image is presented in FIG. 9a, from which we can see that the grain sizes are in the range of 50-300 nm with an estimated average size being about 100-200 nm. Therefore, there is a significant grain growth during the hot pressing process. The selected area electron diffraction (SAED) pattern (inset of FIG. 9a) of each individual grains indicates that the individual grains are single-crystalline. The high resolution TEM image (FIG. 9b) demonstrates the good crystallinity inside each individual grains. FIG. 9c shows one nanodot (i.e., small crystalline inclusion) embedded inside the matrix, such dots having a size (e.g., width or diameter) of 10-50 nm are commonly observed in most of the grains. The compositions of both the nanodot and its surrounding areas are checked by energy dispersive spectroscopy (EDS), showing Hf rich and Co deficient composition for the nanodot compared to the sample matrix (i.e., the larger grains). Another feature pertaining to the sample is that small grains (˜30 nm) are also common (FIG. 9d), which have similar composition as the surrounding bigger grains determined by EDS. It is believed that the non-uniformity in both the grain sizes and the composition all contribute to the reduction of thermal conductivity.

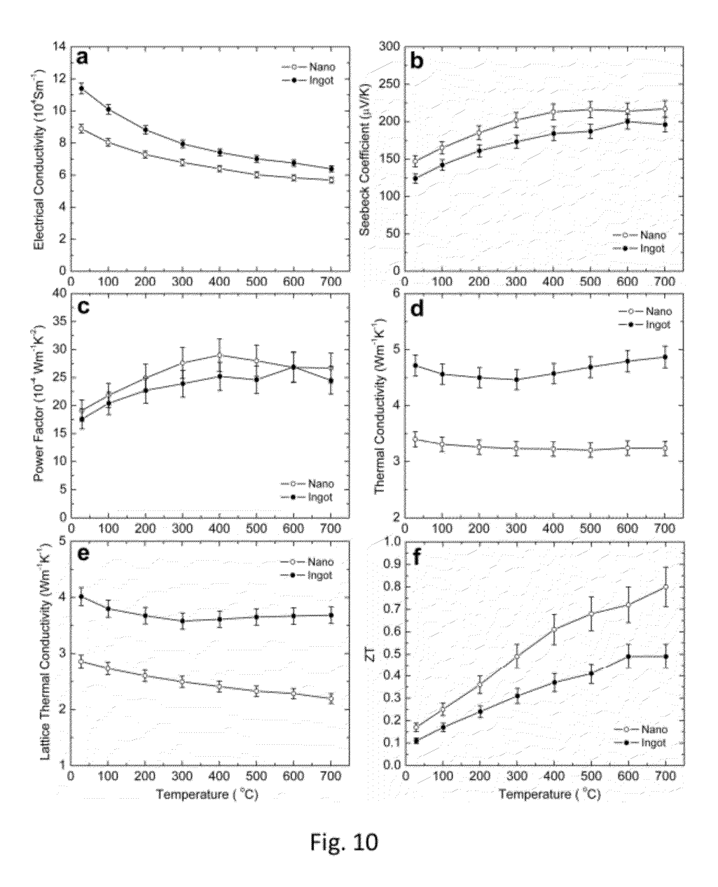

The temperature-dependent thermoelectric (TE) properties of the hot pressed Hf_{0.5}Zr_{0.5}CoSb_{0.8}Sb_{0.2} bulk samples in comparison with that of the ingot are plotted in FIG. 10. For all of the samples examined, the temperature-dependence of the electrical conductivity was found to exhibit semimetallic or degenerate semiconductor behavior (FIG. 10a). Specifically, the electrical conductivities of all the ball milled and hot pressed samples are lower than that of the ingot. The mobility and carrier concentration at room temperature have been measured to be 3.86 cm²V⁻¹s⁻¹ and 1.6×10²¹ cm⁻³, respectively. The mobility is lower than the previously reported value while the carrier concentration is higher. Electrical conductivities of our ball milled samples decrease slowly at the higher temperature range. The Seebeck coefficients (FIG. 10b) of the ball milled samples are higher than that of the ingot for the whole temperature range. These facts strongly indicate that grain boundaries may be trapping electrons, leading to increased holes in the sample and energy filtering effect where low energy holes are preferentially scattered at the grain boundaries. As a result of the improvement in the Seebeck coefficient and a slight decrease in the electrical conductivity, the power factor (FIG. 10c) of ball milled and hot pressed samples is higher than that of the ingot. The total thermal conductivity of the ball milled and hot pressed samples (FIG. 10d) decreases gradually with temperature up to 500° C. and does not change too much after that, which shows a much weaker bi-polar effect. The reduction of the thermal conductivity in the ball milled and hot pressed nanostructured samples compared with the ingot is mainly due to the increased phonon scattering at the numerous interfaces of the random nanostructures. To get a quantitative view of the effect of ball milling and hot pressing on phonon transport, the lattice thermal conductivity (κₗ) was estimated by subtracting the electronic contribution (κₑ) from the total thermal conductivity (κ). The electronic contribution to the thermal conductivity (κₑ) can be estimated using the Wiedemann-Franz law. The Lorenz number can be obtained from the reduced Fermi energy, which can be calculated from the Seebeck coefficient at room temperature and the two band theory. Within expectation, the lattice part of the thermal conductivity (FIG. 10e) decreases with temperature. For the ingot sample, κₑ=0.7 Wm⁻¹K⁻¹ and κₗ=4.01 Wm⁻¹K⁻¹ were obtained at room temperature, whereas for the ball milled and hot pressed samples κₑ=0.54 Wm⁻¹K⁻¹ due to a lower electrical conductivity and κₗ=2.86 Wm⁻¹K⁻¹ at room temperature. The lattice thermal conductivity of the ball milled and hot pressed samples at room temperature is about 29% lower than that of the ingot, which is mainly due to a stronger boundary scattering in the nanostructured sample. It appears that the lattice part is still a large portion of the total thermal conductivity. If an average grain size below 100 nm is achieved during hot pressing, the thermal conductivity can be expected to be further reduced. The slightly improved power factor, coupled with the significantly reduced thermal conductivity, makes the ZT (FIG. 10f) of the ball milled and hot pressed samples greatly improved in comparison with that of the ingot. The peak ZT of all the ball milled and hot pressed samples reached 0.8 at 700° C., a 60% improvement over the believed highest journal reported ZT value of 0.5 obtained in ingot, showing promise as p-type material for high temperature applications. Thus, p-type half-Heusler materials with ZT≧0.7 at high temperatures (e.g., 600-700° C.), such as 0.7-0.8 are obtained.

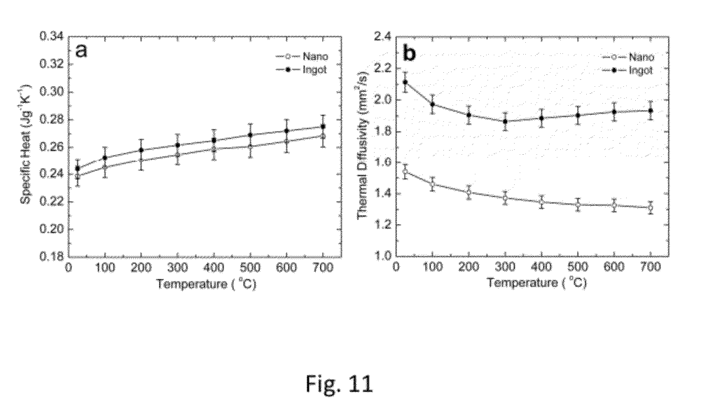

The specific heat (FIG. 11a) and thermal diffusivity (FIG. 11b) of the ball milled and hot pressed samples compared with that of the ingot sample. The specific heat (FIG. 11a) of both the ingot and the ball milled and hot pressed samples increases steadily with temperature up to 600° C. (the limit of our DSC measurement instrument). The specific heat value at 700° C. was obtained by a reasonable extrapolation. The specific heat difference of about 3% is within the experimental error of the measurement. It is clear that the major decrease is in thermal diffusivity (FIG. 11b) with the ball milled and hot pressed sample consistently lower than that of the ingot sample for the whole temperature range, which is the solid evidence showing the effect of grain boundaries on phonon scattering.

In summary, enhancement in ZT of p-type half-Heusler alloys was achieved. The average grain size of 100-200 nm of the hot pressed bulk samples is much larger than the 5-10 nm particle size of the ball milled precursor nanopowders, which is why the lattice thermal conductivity is still relatively high. If the grain size of the original nanopowders is preserved, such as with a grain growth inhibitor, a lower thermal conductivity and thus a much higher ZT can be expected. Besides boundary scattering, minor dopants, such as the Group VIA elements in the Periodic Table (e.g., S, Se, Te) on the Sb site, or the Group IVA elements (e.g., C, Si, Ge, Pb) on the Sn site, or the alloying or substituting of the Co or Ni with other transition metal elements (e.g., Fe, Cu, etc.), may also be introduced to enhance the alloy scattering, provided that they do not deteriorate the electronic properties. The ZT values are very reproducible within 5% from run to run on more than 10 samples made under similar conditions.

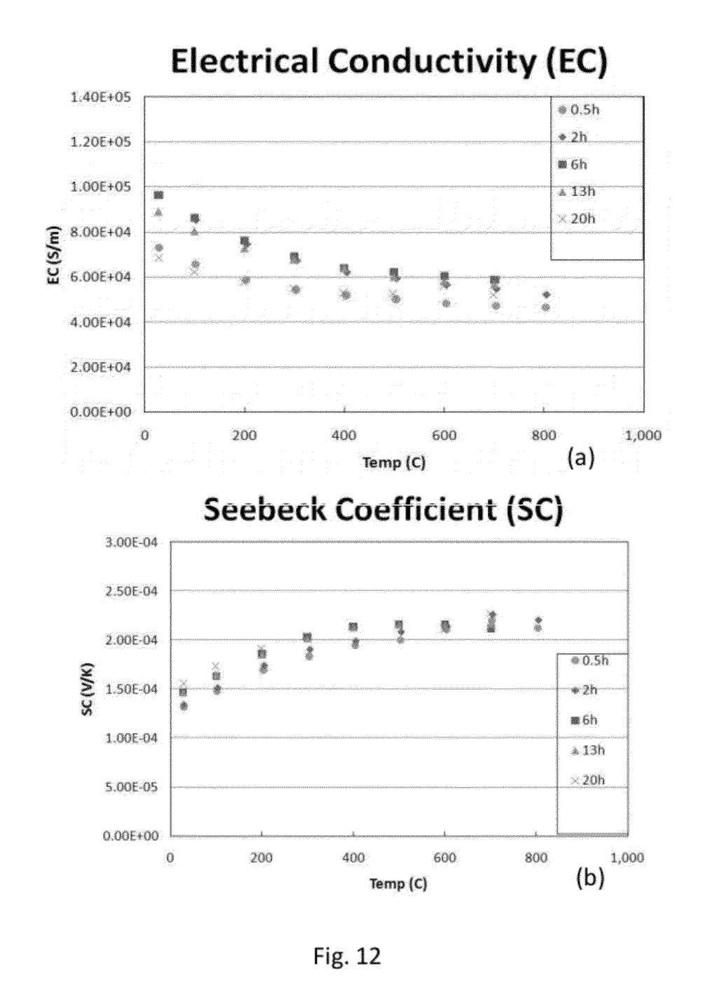

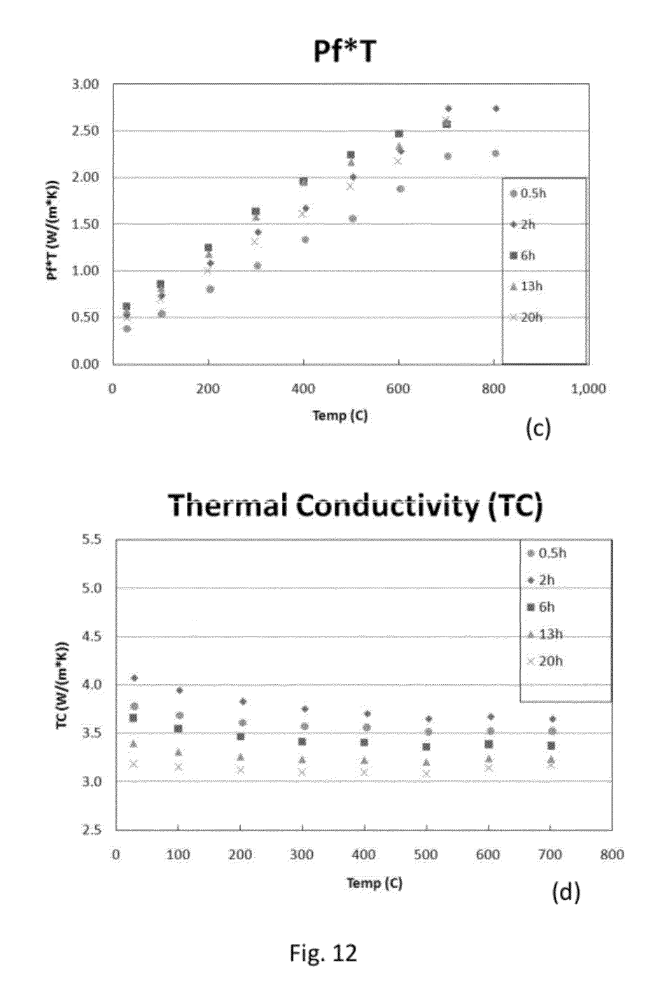

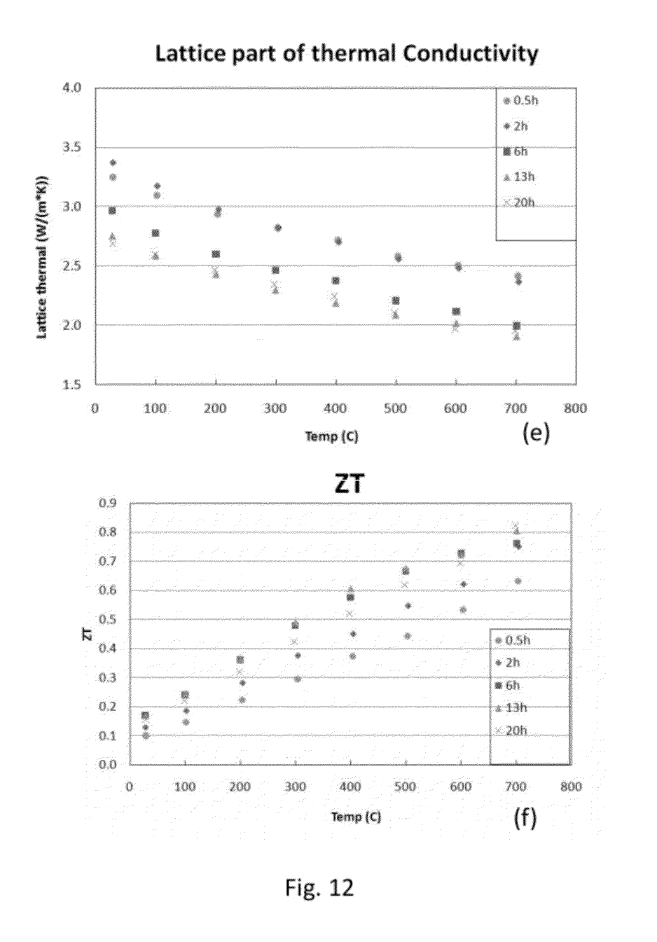

FIG. 12 illustrates the effect of bill mill time on the temperature-dependent (a) electrical conductivity, (b) Seebeck coefficient, (c) power factor, (d) total thermal conductivity, (e) lattice part of thermal conductivity, and (f) ZT of ball milled and hot pressed Hf_{0.5}Zr_{0.5}CoSb_{0.8}Sn_{0.2}. Samples were ball milled for 0.5, 2, 6, 13 and 20 hours shown by the circle, diamond, square, triangle and “x” symbols, respectively, in FIG. 12. TEM and SEM analysis verified that increasing ball mill time resulted in smaller size nanoparticles and increases in ZT.

Therefore, as shown in FIGS. 10 and 12, for the p-type thermoelectric material, the figure of merit, ZT, is greater than 0.5 at a temperature greater than 400° C., such 0.5 to 0.82 in a temperature range of 400 to 700° C. For example, ZT is greater than 0.6 at a temperature greater than or equal to 500° C., such as such 0.6 to 0.82 in a temperature range of 500 to 700° C. ZT is greater than 0.7 at a temperature greater than or equal to 600° C., such as such 0.7 to 0.82 in a temperature range of 600 to 700° C. ZT is equal to or greater than 0.8 (e.g., 0.8 to 0.82) at a temperature of 700° C. Thus, for example, the improvement of ZT at 700° C. is greater than 60% (0.5 to 0.8).

### PREFERRED EMBODIMENTS

The inventors have discovered that replacing Hf with Ti in n-type half Heusler thermoelectric materials lowers the thermal conductivity and raises the figure of merit. Additionally, the inventors have discovered that replacing Zr with Ti in p-type half Heusler thermoelectric materials lowers the thermal conductivity of these materials and raises the figure of merit. The following are examples of methods and thermoelectric materials of these embodiments. These examples are illustrative and not meant to be limiting.

n-Type Half-Heusler Materials

The effect of titanium partial substitution for hafnium on thermoelectric properties of hafnium and zirconium-based n-type half-Heuslers have been studied by using a nanocomposite approach. A peak ZT of 1.0 is observed at 500° C. in samples with a composition of Hf_{0.5}Zr_{0.25}Ti_{0.25}NiSn_{0.99}Sb_{0.01}. The ZT values of Hf_{0.5}Zr_{0.25}Ti_{0.25}NiSn_{0.99}Sb_{0.01} are significantly higher than those of Hf_{0.75}Zr_{0.25}NiSn_{0.99}Sb_{0.01} at lower temperatures, which is very much desired for mid-range temperature applications such as waste heat recovery in car exhaust systems.

Significant improvements in ZT are found at lower temperatures, such as less than 750° C., such as 300-750° C., such as 400-600° C., with a peak ZT of 1.0 at 500° C. in (Hf, Zr, Ti) based n-type nanostructured HHs by using the cost-effective and mass-producible nanocomposite approach. The ZT improvement at lower temperatures and the shift in peak ZT benefits from the change in carrier concentration caused by the partial substitution of Ti for Hf.

Even though the peak ZT remains comparable with the previously reported results, the shift in the peak of ZT values toward lower temperatures (e.g., the ZT peak is located between 400 and 600° C., such as about 500° C. and is greater than 0.9 in this temperature range) is desirable for medium temperature applications such as waste heat recovery in vehicles. These nanostructured samples are prepared by dc hot pressing the ball milled nanopowders of an ingot which is initially made by arc melting process. These nanostructured samples comprise polycrystalline grains of sizes ranging from 200 nm and up with random orientations.

### Experimental

Nanostructured half-Heusler phases were prepared by melting hafnium (Hf) (99.99%, Alfa Aesar), titanium (Ti) (99.99%, Alfa Aesar), and zirconium (Zr) (99.99%, Alfa Aesar) chunks with nickel (Ni) (99.99%, Alfa Aesar), tin (Sn) (99.99%, Alfa Aesar), and antimony (Sb) (99.99%, Alfa Aesar) pieces according to the required composition (Hf, Ti, Zr)Ni(Sn, Sb) using arc melting process. Then the melted ingot was ball milled for 5-20 hours to get the desired nanopowders. The mechanically prepared nanopowders were then pressed at temperatures of 1000-1050° C. by a dc hot pressing method in graphite dies with a 12.7 mm central cylindrical opening diameter to get bulk nanostructured half-Heusler samples.

The samples were characterized by X-ray diffraction (XRD) and transmission electron microscopy (TEM) to study their crystallinity, composition, homogeneity, the average grain size, and grain size distribution of the nano particles. These parameters affect the thermoelectric properties of the final dense bulk samples. The volumetric mass densities of these samples were measured using an Archimedes' kit.

The nanostructured bulk samples were then cut into 2 mm×2 mm×12 mm bars for electrical conductivity and Seebeck coefficient measurements, 12.7 mm diameter discs with appropriate thickness for thermal diffusivity and Hall coefficient measurements, and 6 MITI diameter discs with appropriate thickness for specific heat capacity measurements. The electrical conductivity and Seebeck coefficient were measured by commercial equipment (ZEM-3, Ulvac), the thermal diffusivity was measured by a laser flash system (LFA 457, Netzsch) from room temperature to 700° C., the carrier concentration and mobility at room temperature were tested from Hall measurements, and the specific heat capacity was measured on a differential scanning calorimeter (200-F3, Netzsch Instruments, Incl. The thermal conductivity was calculated as the product of the thermal diffusivity, specific heat capacity, and volumetric density of the samples. The volumetric densities are 9.73, 9.01, 8.17, and 7.74 gcm⁻³ for Hf_{0.75-x}TiₓZr_{0.25}NiSn_{0.99}Sb_{0.01} with x=0, 0.25, 0.5, and 0.65, respectively,

### Results and Analyses

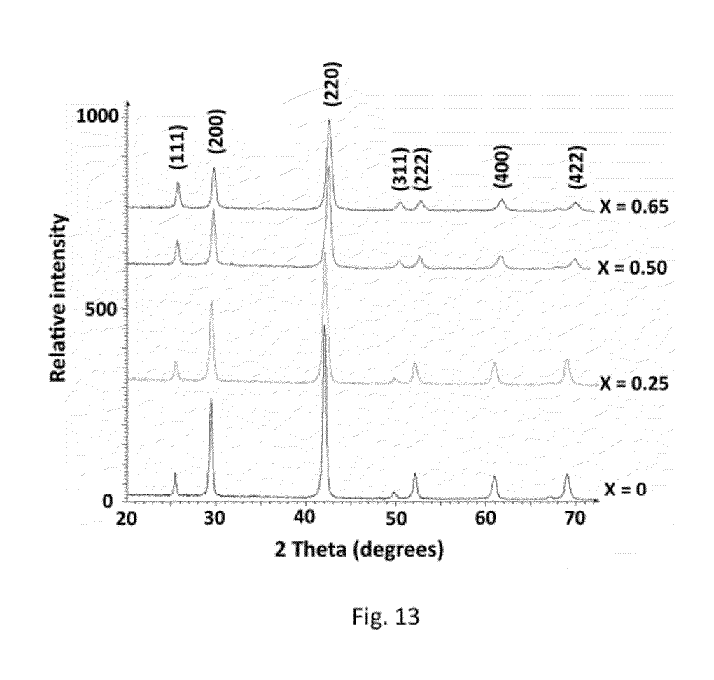

The results for the temperature dependent thermoelectric properties for n-type half-Heusler phase of compositions Hf_{0.75-x}TiₓZr_{0.25}NiSn_{0.99}Sb_{0.01} (x=0, 0.25, 0.5, and 0.65) are illustrated in FIGS. 13-16. FIG. 13 shows the XRD patterns of the arc melted and ball milled samples of Hf_{0.75}TiₓZr_{0.25}NiSn_{0.99}Sb_{0.01} (x=0, 0.25, 0.5, and 0.65) compositions. The XRD patterns of all compositions are similar and well matched with those obtained for half-Heusler phases showing good quality of the sample for better thermoelectric properties.

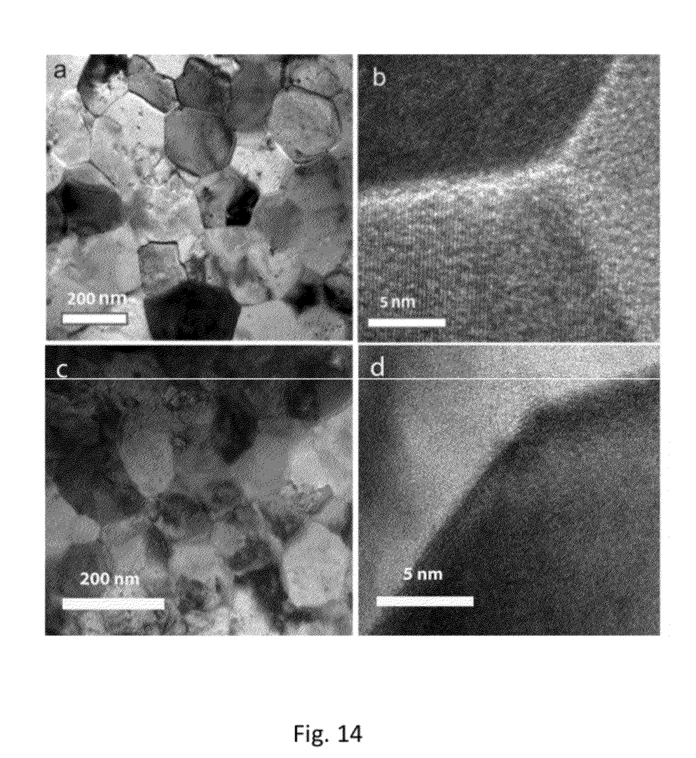

FIG. 14 shows TEM images of the arc melted and ball milled samples of Hf_{0.75}Zr_{0.25}NiSn_{0.99}Sb_{0.01} (FIGS. 14a and 14b) and Hf_{0.5}Ti_{0.25}NiSn_{0.25}NiSn_{0.99}Sb_{0.01} (FIGS. 14c and 14d) compositions. FIGS. 14a-14d clearly show that the ball milled and hot-pressed samples of both Hf_{0.75}Zr_{0.25}NiSn_{0.99}Sb_{0.01} (FIG. 14a) and Hf_{0.5}Ti_{0.25}Zr_{o0.25}NiSn_{0.99}Sb_{0.01} compositions (FIG. 14c) contains the grains of around 200-300 nm sizes showing no difference in grain size due to Ti substitution. FIG. 14 also shows that the grain boundaries and crystallinity of both samples are similar (FIGS. 14b and 14d).

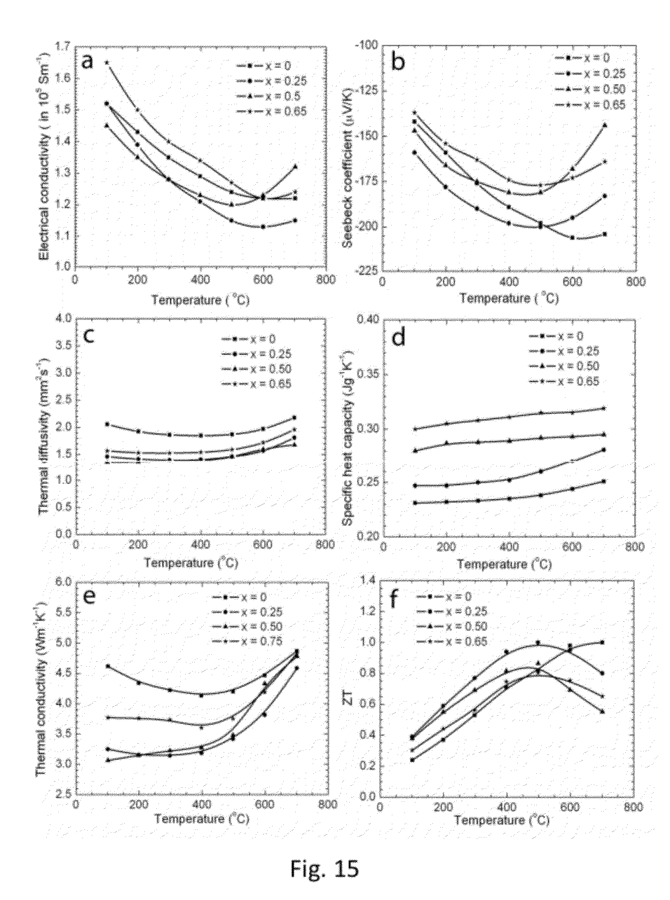

FIG. 15 show the temperature dependent electrical conductivity (FIG. 15a), Seebeck coefficient (FIG. 15b), thermal diffusivity (FIG. 15c), specific heat capacity (FIG. 15d), thermal conductivity (FIG. 15e), and ZT (FIG. 15f) of nanostructured Hf_{0.75-x}TiₓZr_{0.25}NiSn_{0.99}Sb_{0.01} (x=0.25, 0.5, and 0.65) compositions in comparison to the previously reported (Hf, Zr) based best n-type half-Heusler composition (Hf_{0.75}Zr_{0.25}NiSn_{0.99}Sb_{0.01}) prepared through arc melting and ball milling process. FIGS. 15a and 15b clearly show that the electrical resistivity and Seebeck coefficient increase a little bit and then decrease with the increase of Ti concentration. However, the thermal diffusivity of Ti substituted samples [Hf_{0.75-x}TiₓZr_{0.25}NiSn_{0.99}Sb_{0.01} (x=0.25, 0.5, and 0.65)] is significantly lower than those of Hf_{0.75}Zr_{0.25}NiSn_{0.99}Sb_{0.01} composition (FIG. 15c) showing alloy scattering effect. Since, the specific heat capacity increases with increasing Ti content (FIG. 15d) due to lower atomic mass, the thermal conductivity of Ti substituted samples decreases at lower temperatures in comparison to Hf_{0.75}Zr_{0.25}NiSn_{0.99}Sb_{0.01} sample (FIG. 15e). As a result, the ZT values are improved at lower temperatures with a peak ZT of 1.0 at 500° C. in Hf_{0.5}Ti_{0.25}Zr_{0.25}NiSn_{0.99}Sb_{0.01} composition in comparison to the previously reported (Hf, Zr) based best n-type half-Heusler composition (Hf_{0.75}Zr_{0.25}NiSn_{0.99}Sb_{0.01}) (FIG. 2f). The improvement in ZT at lower temperatures could be beneficial for medium temperature applications such as waste heat recovery in vehicles.

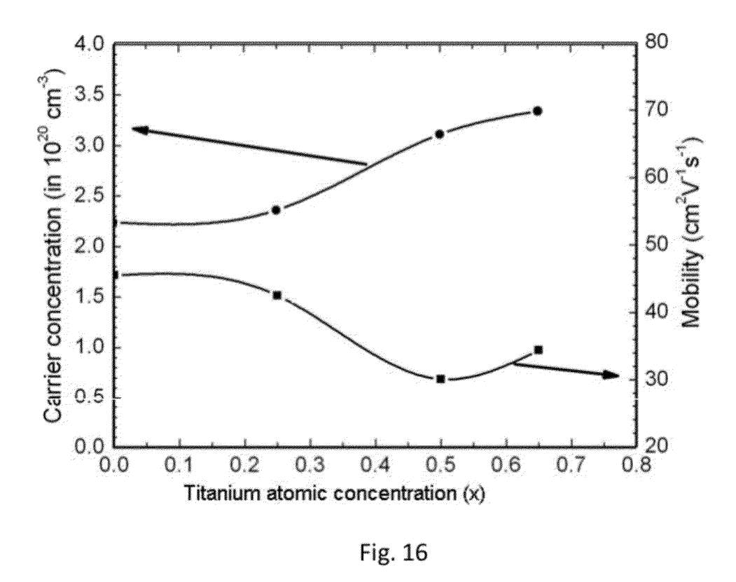

FIG. 16 shows the room temperature carrier concentration and mobility of nanostructured Hf_{0.75-x}TiₓZr_{0.25}NiSn_{0.99}Sb_{0.01} (x=0.25, 0.5, and 0.65) compositions. FIG. 16 clearly shows that the behaviors of electrical conductivity (FIG. 15a) and Seebeck coefficient (FIG. 15b) in Hf_{0.75-x}TiₓZr_{0.25}NiSn_{0.99}Sb_{0.01} (x=0.25, 0.5, and 0.65) compositions are due to the increase in carrier concentration and decrease in mobility with the Ti concentration. The increase in carrier concentration with Ti concentration (FIG. 16) could be possibly due to the decrease in band gap after Ti substitution. It is clear that the carrier concentration in the range of (2-3)×10²⁰ cm⁻³ is too high. Further optimization of the composition may improve the ZT much higher than 1. Therefore, the preferred composition of this embodiment is a half-Heusler material having a formula Hf_{1-x-y}ZrₓTi_{y}NiSn_{1-z}Sb_{z}, where 0≦x≦1, 0≦y≦1, 0≦z≦1, preferably, 0≦x≦0.5, 0≦y≦0.5, 0≦z≦0.2.

Thermoelectric properties of titanium, zirconium, and hafnium (Ti, Zr, Hf) based n-type half-Heuslers have been studied by using a cost effective nanocomposite approach, and a peak ZT of 1.0 is observed at 500° C. in nanostructured Hf_{0.5}Zr_{0.25}Ti_{0.25}NiSn_{0.99}Sb_{0.01} composition. The nanostructured samples are initially prepared by ball milling and hot pressing of arc melted samples. The peak ZT value did not increase but the ZT values are improved at lower temperatures. The improved ZT at lower temperatures could be significant for medium temperature applications such as waste heat recovery.

p-Type Half-Heusler Materials

High lattice thermal conductivity has been the bottleneck for further improvement of thermoelectric figure-of-merit (ZT) of half-Heuslers (HHs) Hf₁₋ₓZrₓCoSb_{0.8}Sn_{0.2}. Theoretically the high lattice thermal conductivity can be reduced by exploring larger differences in atomic mass and size in the crystal structure. This embodiment demonstrates that lower than ever reported thermal conductivity in p-type HHs can indeed be achieved when Ti is used to replace Zr, i.e., Hf₁₋ₓTiₓCoSb_{0.8}Sn_{0.2}, due to larger differences in atomic mass and size between Hf and Ti than Hf and Zr. The highest peak ZT of about 1.1 in the system Hf₁₋ₓTiₓCoSb_{0.8}Sn_{0.2} (0.1≦x≦0.5; x=0.1, 0.2, 0.3, and 0.5) was achieved with x=0.2 at 800° C.

The investigation of the thermoelectric properties of Hf₁₋ₓTiₓCoSb_{0.8}Sn_{0.2} (0.1≦x≦0.5; x=0.1, 0.2, 0.3, and 0.5) proves that Hf_{0.8}Ti_{0.2}CoSb_{0.8}Sn_{0.2} has indeed the lowest thermal conductivity ˜2.7 Wm⁻¹K⁻¹ leading to the highest ZT of greater than 1, such as about 1.1 at 800° C. due to the strong phonon scattering without too much penalty on the power factor.

### Methods

Alloyed ingots with compositions Hf₁₋ₓTiₓCoSb_{0.8}Sn_{0.2} (x=0.1, 0.2, 0.3, and 0.5) were first formed by arc melting a mixture of appropriate amount of individual elements according to the stoichiometry. Then the ingot was loaded into a ball milling jar with grinding balls inside an argon-filled glove box and then subjected to a mechanical ball-milling process to make nanopowders. Finally bulk samples were obtained by consolidating the nanopowders into pellets with a diameter of 12.7 mm, using the direct current induced hot-press method. X-ray diffraction (XRD) (PANalytical X′Pert Pro) analysis with a wavelength of 0.154 nm (Cu Kα) was performed on as-pressed samples with different Hf/Ti ratios. The freshly fractured surface of as-pressed Hf_{0.8}Ti_{0.2}CoSb_{0.8}Sn_{0.2} samples was observed by scanning electron microscope (SEM) (JEOL) and transmission electron microscope (TEM).

To measure the thermoelectric properties of bulk samples, bars of about 2×2×12 mm and disks of 12.7 mm in diameter and 2 mm in thickness were made. The bar samples were used to measure the electrical conductivity and Seebeck coefficient on a commercial equipment (ULVAC, ZEM3). The disk samples were used to obtain the thermal conductivity, which is calculated as the product of thermal diffusivity, specific heat, and volumetric density. The volumetric density was measured using an Archimedes' kit. The specific heat was determined by a High-Temperature DSC instrument (404C, Netzsch Instruments, Inc.). The thermal diffusivity was measured using laser flash system (LFA 457 Nanoflash, Netzsch Instruments, Inc.). The uncertainties are 3% for electrical conductivity, thermal diffusivity, and specific heat, and 5% for the Seebeck coefficient, leading to an 11% uncertainty in ZT.

The experiments were repeated several times and confirmed that the peak ZT values were reproducible within experimental errors. Additionally, the same sample was measured up to 800° C. again after the first measurement and found that there was no degradation in both individual properties and the ZTs.

### Results and Discussions

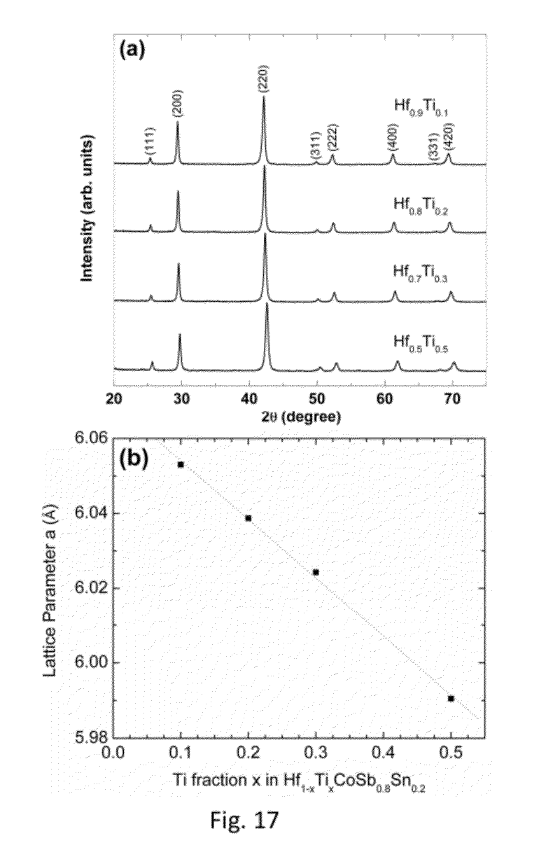

FIG. 17a shows the XRD patterns of the as-pressed Hf₁₋ₓTiₓCoSb_{0.8}Sn_{0.2} (x=0.1, 0.2, 0.3, and 0.5) samples. The diffraction peaks of all samples are well-matched with those of half-Heusler phases. No noticeable impurity phases are observed. A close scrutiny reveals that XRD peaks shift towards higher angles with increasing Ti, suggesting that Ti replace the Hf to form alloys. The lattice parameters a of all samples has been estimated with different Hf/Ti ratios and plotted the results with respect to Ti fraction x in FIG. 17b. As expected, the lattice parameter decreases linearly with increasing Ti, following the Vegard's law.

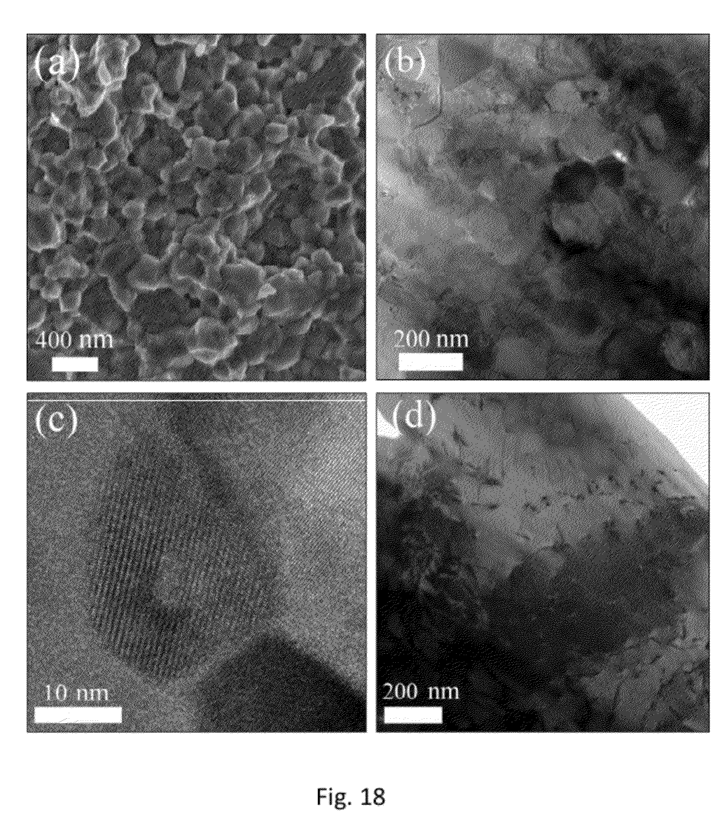

The SEM image of the as-pressed Hf_{0.8}Ti_{0.2}CoSb_{0.8}Sn_{0.2} sample is displayed in FIG. 18a, where the grain sizes are in the range of 50-300 nm with an estimated average size about 100-200 nm. The TEM image (FIG. 18b) confirms the average grain size observed from the SEM image, which is ˜200 nm and below. FIG. 18c shows two nanodots sitting on the grain boundaries. These nanodots are commonly observed inside the samples. One feature pertaining to the samples is that dislocations are also common, as shown in FIG. 18d. The origin of the dislocations is still under investigation. The small grains, nanodots, and dislocations are all favorable for a low lattice thermal conductivity due to enhanced phonon scattering.

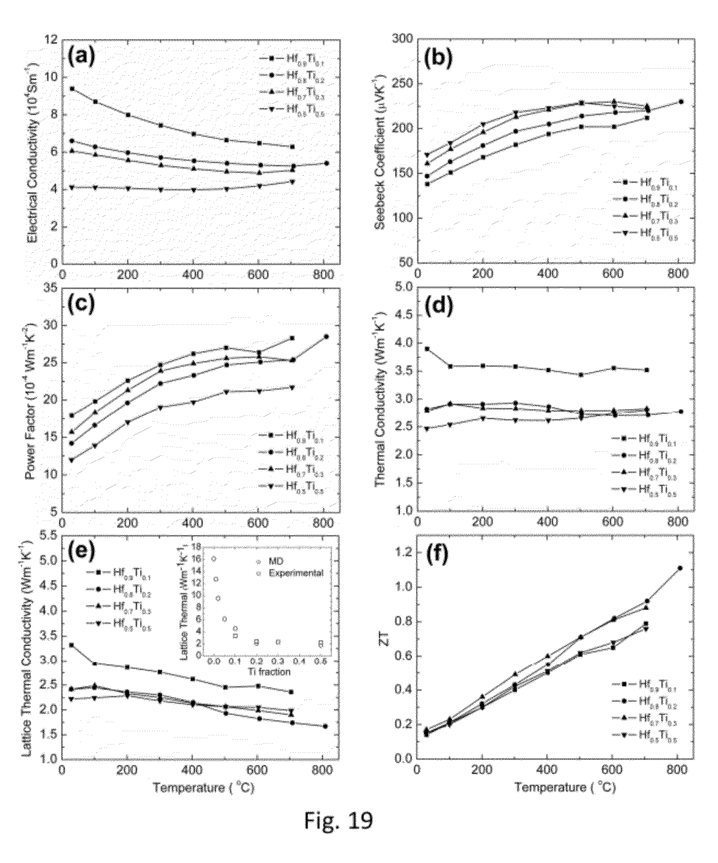

FIG. 19 shows the temperature-dependent thermoelectric (TE) properties of Hf₁₋ₓTiₓCoSb_{0.8}Sn_{0.2} (x=0.1, 0.2, 0.3, and 0.5) samples. All these samples have been made by ball milling the as-arc-melted ingot using the same ball milling time and hot pressing conditions. The electrical conductivities are plotted in FIG. 19a, where electrical conductivity decreases with increasing Ti for the whole temperature range. In addition, bipolar effect starts to take place at lower temperatures when Ti changes from 0.1 to 0.5. The Seebeck coefficient follows roughly the trend of increasing with increasing of Ti, opposite to the trend of electrical conductivity (FIG. 19b). Meanwhile, the differences in Seebeck coefficients among various compositions are diminished at elevated temperatures. FIG. 19c demonstrates the temperature-dependent power factor. Hf_{0.9}Ti_{0.1}CoSb_{0.8}Sn_{0.2} has the highest power factor whereas Hf_{0.5}Ti_{0.5}CoSb_{0.8}Sn_{0.2} has the lowest power factor for the whole temperature range. Benefiting from weaker bipolar effect, the power factor of Hf_{0.8}Ti_{0.2}CoSb_{0.8}Sn_{0.2} increases steadily with respect to temperature and reaches as high as 28.5×10⁻⁴ Wm⁻¹K⁻² at 800° C.

FIG. 19d shows the temperature-dependent total thermal conductivity of Hf₁₋ₓTiₓCoSb_{0.8}Sn_{0.2} (x=0.1, 0.2, 0.3, and 0.5) samples. For the whole temperature range, thermal conductivities of Hf_{0.8}Ti_{0.2}CoSb_{0.8}Sn_{0.2}, Hf_{0.7}Ti_{0.3}CoSb_{0.8}Sn_{0.2}, and Hf_{0.5}Ti_{0.5}CoSb_{0.8}Sn_{0.2} samples are similar with each other and much lower than that of Hf_{0.9}Ti_{0.1}CoSb_{0.8}Sn_{0.2}. The thermal conductivity of Hf_{0.8}Ti_{0.2}CoSb_{0.8}Sn_{0.2} changes very little with increasing temperature and the minimum value is 2.7 Wm⁻¹K⁻¹, the lowest achieved in p-type half-Heusler system. To get a clear view of how Hf/Ti ratio affects the lattice heat transport, the lattice thermal conductivity (κₗ) was estimated by subtracting both the electronic contribution (κₑ) and the bipolar contribution (κ_{bipolar}) from the total thermal conductivity (κ) while κₑ was obtained using the Wiedemann-Franz law. The Lorenz number was calculated from the reduced Fermi energy, which was estimated from the Seebeck coefficient at room temperature and the two band theory. Similar with the total thermal conductivity, lattice thermal conductivities of Hf_{0.8}Ti_{0.2}CoSbₒ₈Sn_{0.2}, Hf_{0.7}Ti_{0.3}CoSb_{0.8}Sn_{0.2}, and Hf_{0.5}Ti_{0.5}CoSb_{0.8}Sn_{0.2} samples are similar with each other and much lower than that of Hf_{0.9}Ti₀₁CoSbₒ₈Sn_{0.2} (FIG. 19e). A close look indicates that the lattice thermal conductivity of Hf_{0.8}Ti_{0.2}CoSb_{0.8}Sn_{0.2} is the lowest at temperatures above 400° C., which may be due to some underestimates of the bipolar thermal conductivities for both Hf_{0.7}Ti_{0.3}CoSb_{0.8}Sn_{0.2} and Hf_{0.5}Ti_{0.5}CoSb_{0.8}Sn_{0.2} at elevated temperatures. As Ti is gradually introduced into HfCoSb_{0.8}Sn_{0.2} system, lattice thermal conductivity experiences a sharp suppression from x=0.1 to x=0.2 and then becomes almost saturated above x=0.2. The theoretical calculations on Hf₁₋ₓTiₓCoSb using molecular dynamics (MD) simulations via the harmonic and cubic force interatomic constants obtained from first principles calculations predicted such thermal conductivity decrease. The lattice thermal conductivities of Hf₁₋ₓTiₓCoSb_{0.8}Sn_{0.2} (x=0.1, 0.2, 0.3, and 0.5) samples at room temperature are plotted in the inset of FIG. 19e in comparison with the calculations. It is very encouraging to see that our experimental data and the theoretical calculations are in very good agreement.

Because of the low thermal conductivity and high power factor achieved by partially substituting Hf with Ti, ZT of Hf_{0.8}Ti_{0.2}CoSb_{0.8}Sn_{0.2} reached 1.1 at 800° C. and 0.9 at 700° C. (FIG. 19f), the highest ever reported value for p-type half-Heuslers, showing great promise for p-type material as an option in high temperature applications. For the first time, p-type half-Heusler materials have ZT above 1, the minimum ZT to be considered for real applications.

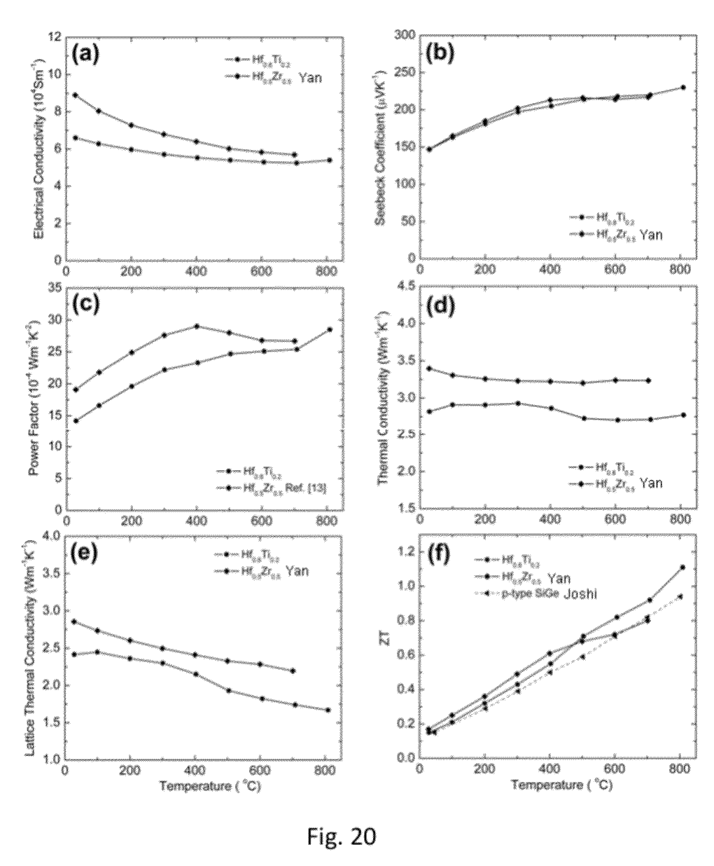

In order to have an intuitive view of how large differences in atomic mass and size affect individual TE properties as well as ZT, the temperature-dependent TE properties of nanostructured bulk sample Hf_{0.8}Ti_{0.2}CoSb_{0.8}Sn_{0.2} in comparison with that of Hf_{0.5}Zr_{0.5}CoSb_{0.8}Sn_{0.2} described in X. Yan et al., Nano Lett. 11, 556-560 (2011) are plotted in FIG. 20. Both samples have been subjected to the same ball milling and hot pressing conditions to minimize the size effect on the transport properties. The electrical conductivity of Hf_{0.5}Zr_{0.5}CoSb_{0.8}Sn_{0.2} is higher than that of Hf_{0.8}Ti_{0.2}CoSb_{0.8}Sn_{0.2} for the whole temperature range and the difference becomes smaller with increasing temperature (FIG. 20a). In contrast, the Seebeck coefficient of Hf_{0.8}Ti_{0.2}CoSb_{0.8}Sn_{0.2} is almost the same with that of Hf_{0.5}Zr_{0.5}CoSb_{0.8}Sn_{0.2} for all the temperatures (FIG. 20b). As a result of the reduced electrical conductivity, the power factor of Hf_{0.8}Ti_{0.2}CoSb_{0.8}Sn_{0.2} is lower than that of Hf_{0.5}Zr_{0.5}CoSb_{0.8}Sn_{0.2} from 100° C. to 700° C. (FIG. 20c). However, this reduced power factor is compensated by the much reduced thermal conductivity (FIG. 20d), which yields an enhanced ZT especially at higher temperatures (FIG. 20f).

The total thermal conductivity of Hf_{0.8}Ti_{0.2}CoSb_{0.8}Sn_{0.2} is ˜17% lower than that of Hf_{0.5}Zr_{0.5}CoSb_{0.8}Sn_{0.2} (FIG. 20d), indicating that the combination of Hf and Ti is more effective in reducing thermal conductivity than the combination of Hf and Zr. The origin of the thermal conductivity reduction achieved in Hf_{0.8}Ti_{0.2}CoSb_{0.8}Sn_{0.2} in comparison with Hf_{0.5}Zr_{0.5}CoSb_{0.8}Sn_{0.2} comes from two parts: electronic part and lattice part. Specifically, κₑ of Hf_{0.8}Ti_{0.2}CoSb₈Sn_{0.2} is about 6%-26% lower than that of Hf_{0.5}Zr_{0.5}CoSb_{0.8}Sn_{0.2}. The lattice thermal conductivity of Hf_{0.8}Ti_{0.2}CoSb_{0.8}Sn_{0.2} is about 8-21% lower than that of Hf_{0.5}Zr_{0.5}CoSb_{0.8}Sn_{0.2} (FIG. 20e), consistent with the effect of more thermal conductivity reduction by Hf and Ti combination in n-type half-Heusler system. The experimental results clearly show that thermal conductivity can be most effectively reduced in the combination of Hf and Ti, owing to the larger difference in atomic mass and size in the case of Hf and Ti combination. However, the lattice part still dominates the total thermal conductivity. If more alloy scattering and/or more boundary scattering by even smaller grains can be achieved, thermal conductivity is expected to be even more reduced. FIG. 20f clearly shows that the ZT of Hf_{0.8}Ti_{0.2}CoSbₒ₈Sn_{0.2} is comparable to that of Hf_{0.5}Zr_{0.5}CoSb_{0.8}Sn_{0.2} at low temperatures and exceeds that of Hf_{0.5}Zr_{0.5}CoSb_{0.8}Sn_{0.2} at temperatures above 500° C. (FIG. 20f), demonstrating great promise for high temperature applications. Data of p-type silicon germanium (SiGe) from G. Joshi et al., Nano Lett. 8, 4670 (2008), another promising p-type material for high temperature applications, are also included for comparison (FIG. 20f). Hf_{0.8}Ti_{0.2}CoSb_{0.8}Sn_{0.2} has also cost advantages over SiGe due to the extremely high cost of Ge.

Although the binary Hf₁₋ₓTi₈CoSb_{0.8}Sn_{0.2} composition has been optimized by tuning the Hf/Ti ratio and demonstrating the feasibility of thermal conductivity reduction and ZT enhancement, there still remains much room for further improvement. First, a ternary combination of Ti, Zr, and Hf at M site has given rise to higher ZT in n-type MNiSn system. However, there is little understanding about the influence of ternary combination of Ti, Zr, and Hf on the transport properties of p-type half-Heuslers, which deserves further investigation. Second, boundary scattering can be enhanced more by preserving nanosize of the precursor nanopowders during hot pressing. Combining enhanced alloying scattering along with enhanced boundary scattering, thermal conductivity is expected to be lowered even more and ZT is most likely to reach even higher.

Thus, in this embodiment, the half-Heusler material has a formula Hf_{1-x-y}ZrₓTi_{y}CoSb₁₋ₓSn_{z}, where 0≦x≦1, 0≦y≦1, 0≦z≦1, preferably, 0≦x≦0.5, 0≦y≦0.5, 0≦z≦0.5. The thermoelectric material preferably has a thermal conductivity<3 Wm⁻¹K⁻¹ at T<800° C., with a minimum thermal conductivity of less than 2.8 Wm⁻¹K⁻¹. The figure of merit, ZT, of this material is preferably greater or equal to 0.85 at 700° C. and greater than 1 at 800° C.

Larger differences in atomic mass and size between Hf and Ti than Hf and Zr at M site of p-type half-Heuslers of the MCoSb type are proved effective on reducing the lattice thermal conductivity by stronger phonon scattering, which leads to what the inventors believe is the lowest ever thermal conductivity of 2.7 Wm⁻¹K⁻¹ in Hf_{0.8}Ti_{0.2}CoSb_{0.8}Sn_{0.2} achieved for the first time in any p-type HHs. As a result, a peak ZT of Hf_{0.8}Ti_{0.2}CoSb_{0.8}Sn_{0.2} reached 1.1 at 800° C., which the inventors believe is the highest ever reported value for any p-type half-Heuslers, which paves the way for consideration of real practical applications of HHs for power generation applications.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A method of making a thermoelectric material having a mean grain size less than 1 micron comprising:
combining and arc melting constituent elements of the thermoelectric material to form a liquid alloy of the thermoelectric material;
casting the liquid alloy of the thermoelectric material to form a solid casting of the thermoelectric material;
ball milling the solid casting of the thermoelectric material into nanometer scale mean size particles; and
sintering the nanometer size particles to form the thermoelectric material having the nanometer scale mean grain size.

2. The method of claim 1, wherein the nanometer mean size particles have a mean size less than 100 nm and 90% of the particles are less than 250 nm in size.

3. The method of claim 2, wherein the nanometer mean size particles have a mean size in a range of 5-100 nm.

4. The method of claim 1, wherein the nanometer scale grain size is a mean grain size less than 300 nm and 90% of the grains are less than 500 nm in size.

5. The method of claim 4, wherein the nanometer scale mean grain size is a mean grain size in a range of 10-300 nm.

6. The method of claim 1, wherein the constituent elements are at least 99.9% pure.

7. The method of claim 6, wherein the constituent elements are at least 99.99% pure.

8. The method of claim 1, wherein the thermoelectric material comprises a half-Heusler material and the constituent elements comprise at least one of Ti, Zr, Hf, at least one of Ni and Co and at least one of Sn and Sb.

9. The method of claim 8, wherein the half-Heusler material has a formula Hf_{1+δ-x-y}ZrₓTi_{y}NiSn_{1+δ-z}Sb_{z}, where 0≦x≦1.0, 0≦y≦1.0, 0≦z≦1.0, and −0.1≦δ≦0.1,

10. The method of claim 9, wherein the half-Heusler material has a formula Hf_{1-x-y}ZrₓTi_{y}NiSn_{1-z}Sb_{z}, where 0≦x≦1.0, 0≦y≦1.0, and 0≦z≦1.0

11. The method of claim 10, wherein the half-Heusler material has a formula Hf_{1-x-y}ZrₓTi_{y}NiSn_{1-z}Sb_{z}, where 0≦x≦0.5, 0≦y≦0.5 and 0≦z≦0.2.

12. The method of claim 8, wherein the half-Heusler material has a formula Hf_{1+δ-x-y}ZrₓTi_{y}CoSb_{1+δ-z}Sn_{z}, where 0≦x≦1.0, 0≦y≦1.0, 0≦z≦1.0, and −0.1≦δ≦0.

13. The method of claim 12, wherein the half-Heusler material has a formula Hf_{1-x-y}ZrₓTi_{y}CoSb_{1-z}Sn_{z}, where 0≦x≦1.0, 0≦y≦1.0, and 0≦z≦1.0.

14. The method of claim 13, wherein the half-Heusler material has a formula Hf_{1-x-y}ZrₓTi_{y}CoSb_{1-z}Sn_{z}, where 0≦x≦0.5, 0≦y≦0.5, and 0≦z≦0.5.

15. The method of claim 1, wherein a figure of merit, ZT, of the thermoelectric material is 20% or more than the figure of merit, ZT, of the same thermoelectric material with a grain size of 1 micron or more.

16. The method of claim 15, wherein the figure of merit, ZT, of the thermoelectric material is 50% or more than the figure of merit, ZT, of the same thermoelectric material with a grain size of 1 micron or more.

17. The method of claim 1, wherein the thermoelectric material is n-type and figure of merit, ZT, is greater than 0.8 at a temperature greater than 600° C.

18. The method of claim 1, wherein the thermoelectric material is p-type and figure of merit, ZT, is greater than 0.5 at a temperature greater than 600° C.

19. The method of claim 1, wherein the sintering is performed by direct current hot pressing.

20. A thermoelectric half-Heusler material comprising grains having at least one of a median grain size and a mean grain size less than one micron.

21. The thermoelectric material of claim 20, wherein a figure of merit, ZT, of the thermoelectric material is 20% or more than the figure of merit, ZT, of the same thermoelectric material with a grain size of 1 micron or more.

22. The thermoelectric material of claim 21, wherein a figure of merit, ZT, of the thermoelectric material is 50% or more than the figure of merit, ZT, of the same thermoelectric material with a grain size of 1 micron or more.

23. The thermoelectric material of claim 20, wherein the thermoelectric material is n-type and figure of merit, ZT, is greater than 0.8 at a temperature greater than or equal to 400° C.

24. The thermoelectric material of claim 23, wherein the thermoelectric material is n-type and figure of merit, ZT, is greater than 0.9 at a temperature greater than or equal to 500° C.

25. The thermoelectric material of claim 24, wherein the thermoelectric material is n-type and figure of merit, ZT, is greater than 0.9 at a temperature greater than or equal to 600° C.

26. The thermoelectric material of claim 23, wherein the ZT is greater than 0.9 at a temperature of 700° C.

27. The thermoelectric material of claim 20, wherein the thermoelectric material is p-type and figure of merit, ZT, is greater than 0.5 at a temperature greater than 400° C.

28. The thermoelectric material of claim 27, wherein the thermoelectric material is p-type and figure of merit, ZT, is greater than 0.6 at a temperature greater than or equal to 500° C.

29. The thermoelectric material of claim 28, wherein the thermoelectric material is p-type and figure of merit, ZT, is greater than 0.7 at a temperature greater than or equal to 600° C.

30. The thermoelectric material of claim 27, wherein the ZT is greater than 0.8 at a temperature of 700° C.

31. The thermoelectric material of claim 20, wherein the half-Heusler material has a formula Hf_{1+δ-x-y}ZrₓTi_{y}NiSn_{1+δ-z}Sb_{z}, where 0≦x≦1.0, 0≦y≦1.0, 0≦z≦1.0, and −0.1≦δ≦0.1,

32. The thermoelectric material of claim 31, wherein the half-Heusler material has a formula Hf_{1-x-y}ZrₓTi_{y}NiSn_{1-z}Sb_{z}, where 0≦x≦1.0, 0≦y≦1.0, and 0≦z≦1.0

33. The thermoelectric material of claim 32, wherein the half-Heusler material has a formula Hf_{1-x-y}ZrₓTi_{y}NiSn_{1-z}Sb_{z}, where 0≦x≦0.5, 0≦y≦0.5 and 0≦z≦0.2.

34. The thermoelectric material of claim 32, wherein the thermoelectric material has a ZT>0.9 and the ZT peaks between 400-600° C.

35. The thermoelectric material of claim 20, wherein the half-Heusler material has a formula Hf_{1+δ-x-y}ZrₓTi_{y}CoSb_{1+δ-z}Sn_{z}, where 0≦x≦1.0, 0≦y≦1.0, 0≦z≦1.0, and −0.1≦δ≦0.

36. The thermoelectric material of claim 35, wherein the half-Heusler material has a formula Hf_{1-x-y}ZrₓTi_{y}CoSb_{1-z}Sn_{z}, where 0≦x≦1.0, 0≦y≦1.0, and 0≦z≦1.0.

37. The thermoelectric material of claim 36, wherein the half-Heusler material has a formula Hf_{1-x-y}ZrₓTi_{y}CoSb_{1-z}Sn_{z}, where 0≦x≦0.5, 0≦y≦0.5, and 0≦z≦0.5.

38. The thermoelectric material of claim 36, wherein:
the thermoelectric material has a thermal conductivity<3 Wm⁻¹K⁻¹ at T<800° C. with a minimum thermal conductivity less than 2.8 Wm⁻¹K⁻¹;
0.15≦x≦0.25;
a Sb to Sn atomic ratio is 70-90:30-10;
ZT≧0.85 at 700° C.; and
ZT>1.0 at 800° C.

39. The thermoelectric material of claim 21, wherein the thermoelectric material has a mean grain size or a median grain size less than 300 nm and 90% of the particles are less than 500 nm in size.

40. The thermoelectric material of claim 39, wherein the thermoelectric material has a mean grain or a median grain size in a range of 10-300 nm.

41. The thermoelectric material of claim 20, further comprising at least one nanodot having a size of 10-50 nm in one or more grains which are Hf rich and either Co or Ni poor with respect to the one or more grains.
